(19) United States
(12) Patent Application Publication
(10) Pub. No.: US 2026/0281518 A1
(43) Pub. Date: Sep. 17, 2026

(54) METHOD AND APPARATUS FOR ENCAPSULATING AND PARSING A MEDIA FILE COMPRISING NEURAL NETWORK BASED POST FILTER INFORMATION

(71) Applicant: CANON KABUSHIKI KAISHA, Tokyo (JP)

(72) Inventors: Franck DENOUAL, SAINT DOMINEUC (FR); Naël OUEDRAOGO, VAL D'ANAST (FR); Lionel TOCZE, SAINT DOMINEUC (FR); Hervé RUELLAN, RENNES (FR); Romain BELLESSORT, SAINT GREGOIRE (FR); Frédéric MAZE, LANGAN (FR)

(21) Appl. No.: 19/168,157

(22) PCT Filed: Apr. 9, 2024
(86) PCT No.: PCT/EP2024/059625

§ 371 Date: Sep. 23, 2025

(30) Foreign Application Priority Data
Apr. 17, 2023 (GB) 2305635.1
Jul. 10, 2023 (GB) 2310585.1

(51) Int. Cl. H04N 21/854; H04N 21/4545; H04N 21/466; H04N 21/81

(52) U.S. Cl. CPC H04N 21/85406; H04N 21/4545; H04N 21/4666; H04N 21/816

(57) ABSTRACT

The present invention concerns a method of encapsulating media data into an ISOBMFF based media file, the media data comprising media data units and at least one post filter data unit, the method comprising: generating a first track encapsulating a sequence of samples, each samples comprising at least one of the media data units, the at least one post filter data unit applying to at least one of the samples of the first track; generating a data part of an entity comprising at least a part of one of said post filter data unit; generating post filter information describing the at least one post filter data unit; and encapsulating the first track, the entity and the post filter information in the media file, the post filter information being encapsulated in a metadata part of the media file.

### FIELD OF THE INVENTION

The present disclosure concerns a method and a device for encapsulating media data in an ISOBMFF based media file and parsing such media files. It concerns more particularly a method for encapsulating neural network-based post filter information associated with the encapsulated media data.

### BACKGROUND OF INVENTION

The ISO base media file format (ISOBMFF, also called file format) is a general format forming the basis for a number of other more specific file formats. ISOBMFF is standardized by the International Standardization Organization as ISO/IEC 14496-12. This format contains characteristics of the media data like the timing, size or media information for timed sequences of media data, such as audio-visual presentations. We call these characteristics metadata (or structure-data), in opposition to media data (or data). Structure data is contained in metadata boxes (e.g. MovieBox ‘moov’ or MovieFragmentBox ‘moof’ or MetaBox ‘meta’) while data is contained in media data box (e.g. MediaDataBox ‘mdat’ or ItemDataBox (‘idat’) or identified media data box ‘imda’). An ISO Base media file (that we later call media file or movie file or media presentation) may come as one file containing the whole presentation, possibly containing movie fragments. It may also come as segment files, each segment file being an ISO base media file containing one or more segment(s). A segment is a portion of a movie file, consisting of either a MovieBox, with its associated media data (if any) and other associated boxes or of one or more MovieFragmentBoxes, with their associated media data, and other associated boxes. An ISO Base media file is structured into “boxes”. In the file format, the overall presentation is called a movie. It is logically divided into tracks; each track represents a timed sequence of media (frames of video, for example). Within each track, each timed unit is called a sample. Each track has one or more sample descriptions; each sample in the track is tied to a description by reference. All the structure-data or metadata, including that defining the placement and timing of the media, is contained in structured boxes. The media data (frames of video, for example) is referred to by this structure-data or metadata. The overall duration of each track is defined in the structure-data. Each sample has a defined duration. The exact decoding timestamp of a sample is defined by summing the durations of the preceding samples.

The V-SEI (Versatile-SEI) specification defines the syntax and semantics of video usability information (VUI) parameters and supplemental enhancement information (SEI) messages. The VUI parameters and SEI messages defined are designed to be conveyed within coded video bitstreams in a manner specified in a video coding specification or to be conveyed by other means determined by the specifications for systems that make use of such coded video bitstreams. This may apply to coded video bitstreams like VVC (ISO/IEC 23090-3), although it is intended to be sufficiently generic that it can also be used with other types of coded video bitstreams (e.g. AVC, HEVC . . . ).

VUI parameters and SEI messages can assist in processes related to decoding, display or other purposes. However, unless otherwise specified in a referencing specification, the interpretation and use of the VUI parameters and SEI messages specified in this document is not a required functionality of a video decoder or receiving video system. Although semantics are specified for the VUI parameters and SEI messages, decoders and receiving video systems can simply ignore the content of the VUI parameters and SEI messages or can use them in a manner that somewhat differs from what is specified in the specification. However, there exist means in File Format to indicate to applications or media players that some SEI messages are considered as important from application point of view (this can be parameterized by content creators and indicated during encapsulation) and should be considered by players to improve the user experience when rendering the media presentation.

In addition to the main specification, an amendment to V-SEI is in progress within JVET group to define additional SEI messages, especially the two following ones: NNPFA for neural-network post-filter activation and NNPFC for neural-network post-filter characteristics. The neural-network post-filter characteristics (NNPFC) SEI message specifies a neural network that may be used as a post-processing filter (or post-filter, as a shortcut). The use of specified post-processing filters for specific pictures is indicated with neural-network post-filter activation SEI messages. The neural-network post-filter activation (NNPFA) SEI message activates or de-activates the possible use of the target neural-network post-processing filter, identified by nnpfa_target_id, for post-processing filtering of a set of pictures. It is to be noted that there can be several NNPFA SEI messages present for the same picture, for example, when the post-processing filters are meant for different purposes or filter different colour components.

Usually in ISOBMFF, SEI messages are stored within sample entries (in metadata part) or within samples (in media data part), depending on the sample entry type. There is an amendment starting in NAL unit-based file format (ISO/IEC 14496-15) that recommends to store NNPFC SEI messages as sample groups, i.e., in the metadata part of the media file. This breaks usual design and moreover it introduces possibly significant amount of data in the metadata part of the file. This is due to the fact that an NNPFC SEI message may embed a payload providing a compressed representation of the neural network model used for the post-filtering operation. This payload may be encoded according to MPEG-7 Part-17 specification (ISO/IEC 15938-17) and may represent mega bytes of data. Putting such payload in the metadata part may induce startup delay when starting playing the media file or when seeking into the file, the delay being introduced by the time to download initialization segment or metadata associated with synchronization samples or stream access points. Moreover, current amendment to Part-15 proposes to simply copy the SEI NAL unit in sample group description entries. Embedding the payload in the sample group description does not provide any information to reader like purpose of the filter or whether the payload in the file does require a fetch from external file. Moreover, having the NNPFA or NNPFC SEI payloads in the sample group description entries does not allow applications to identify filters that are active and to skip filters that would not be useful for application needs (for example, based on their purpose or on complexity). This would require parsers to support the decoding of SEI messages and could not be supported by generic media players.

### SUMMARY OF THE INVENTION

The present invention has been devised to address one or more of the foregoing concerns. It allows declaration of post-filter information in a media track or in some embodiments in an external entity to the media track in a way that allows parser to decide whether to use or to skip post-filter information and that does not introduce delay when starting playing the media file containing the media track or seeking into this media file.

To achieve this, when post-filter information is represented as SEI messages of a video track, the Neural Network based SEI messages are split in two parts: a descriptive part and a payload part. The descriptive part is stored in the media track description or in a dedicated entity (e.g., another track or item or entityGroup) as metadata part of the media file. The payload, when present, is stored (or carried) in a data part of the media track, in a media data box, or in the data part of an external entity associated with the media track. This should keep the size for the description of the post-filter information acceptable.

According to a first aspect of the invention there is provided a method of encapsulating media data into an ISOBMFF based media file, the media data comprising media data units and at least one post filter data unit, the method comprising:
generating a first track encapsulating a sequence of samples, each samples comprising at least one of the media data units, the at least one post filter data unit applying to at least one of the samples of the first track;
generating a data part of an entity comprising at least a part of one of said post filter data unit;
generating post filter information describing the at least one post filter data unit; and
encapsulating the first track, the entity and the post filter information in the media file, the post filter information being encapsulated in a metadata part of the media file.

In an embodiment, the entity is the first track.

In an embodiment, the entity is an item associated with the first track.

In an embodiment, the entity is a second track associated with the first track.

In an embodiment, the post filter information comprises generic information indicating the presence of post filter information.

In an embodiment, generic information indicating the presence of post filter information is a dedicated brand.

In an embodiment, the post filter information further comprises information indicating the purpose of post filter information.

In an embodiment, the post filter information further comprises information indicating the complexity of post filter information.

In an embodiment, post filter information is provided in a sub-box of the first track metadata.

In an embodiment, post filter information is provided in a sample entry of the first track metadata.

In an embodiment, post filter information is provided in a sample group of the first track metadata.

In an embodiment, post filter information is provided in a metadata part of the item.

In an embodiment, post filter information is provided in a metadata part of the second track.

According to another aspect of the invention there is provided a method of generating a bitstream of media data from an ISOBMFF based media file, the method comprising:
obtaining from the media file a first track encapsulating a sequence of samples, each samples comprising at least one media data unit;
obtaining, from a metadata part of the media file, post filter information describing at least one post filter data unit, the at least one post filter data unit applying to at least one of the samples of the first track;
obtaining, from a data part of an entity in the media file, at least a part of one of said post filter data unit; and
generating the bitstream of media data based on the first track, the entity and the post filter information in the media file.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

According to another aspect of the invention there is provided a computer program which upon execution causes the method of the invention to be performed.

According to another aspect of the invention there is provided a device for encapsulating media data into an ISOBMFF based media file, the media data comprising media data units and at least one post filter data unit, the device comprising a processor configured for:
generating a first track encapsulating a sequence of samples, each samples comprising at least one of the media data units, the at least one post filter data unit applying to at least one of the samples of the first track;
generating a data part of an entity comprising at least a part of one of said post filter data unit;
generating post filter information describing the at least one post filter data unit; and
encapsulating the first track, the entity and the post filter information in the media file, the post filter information being encapsulated in a metadata part of the media file.

According to another aspect of the invention there is provided a device for generating a bitstream of media data from an ISOBMFF based media file, the device comprising a processor configured for:
obtaining from the media file a first track encapsulating a sequence of samples, each samples comprising at least one media data unit;
obtaining, from a metadata part of the media file, post filter information describing at least one post filter data unit, the at least one post filter data unit applying to at least one of the samples of the first track;
obtaining, from a data part of an entity in the media file, at least a part of one of said post filter data unit; and
generating the bitstream of media data based on the first track, the entity and the post filter information in the media file.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium. The invention may be embedded in cameras, smartphones, devices recording, packaging or transmitting videos. The parsing part may be embedded in smartphones, TV sets, head mounted displays . . . .

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIGS. 1a, 1b, and 1c illustrate an overview of a method for encapsulating or storing multimedia presentations according to some embodiments of the invention;

FIG. 2 illustrates the main steps of an encapsulation process according to embodiments of the invention;

FIG. 3 illustrates the main steps of a parsing or reading process according to embodiments of the invention;

FIG. 4a illustrates an example metadata structure indicating that post-filter information is available for a track in a media file;

FIG. 4b illustrates an embodiment where, for encapsulating filter data units (FDU) and media data units (MDU), the media file comprises a metadata part comprising boxes which may be some of the generic descriptions or the V-SEI specific mapping;

FIG. 4c illustrates an embodiment where, for encapsulating filter data units (FDU) and media data units (MDU), the media file comprises a metadata part comprising boxes that may include a part of the filter data unit, for example syntax elements describing the post-filter information;

FIG. 5 illustrates an embodiment where the post-filter information is stored outside the media track it applies to;

FIG. 6 illustrates an embodiment where the post-filter information is encapsulated in a dedicated track;

FIG. 7 is a schematic block diagram of a computing device for implementation of one or more embodiments of the invention;

FIG. 8 illustrates another embodiment of the invention.

### DETAILED DESCRIPTION OF THE INVENTION

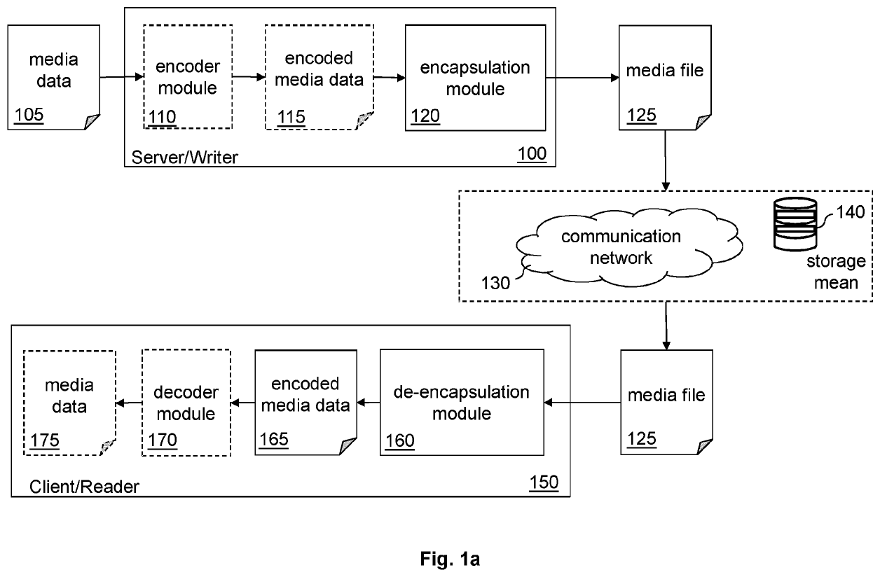

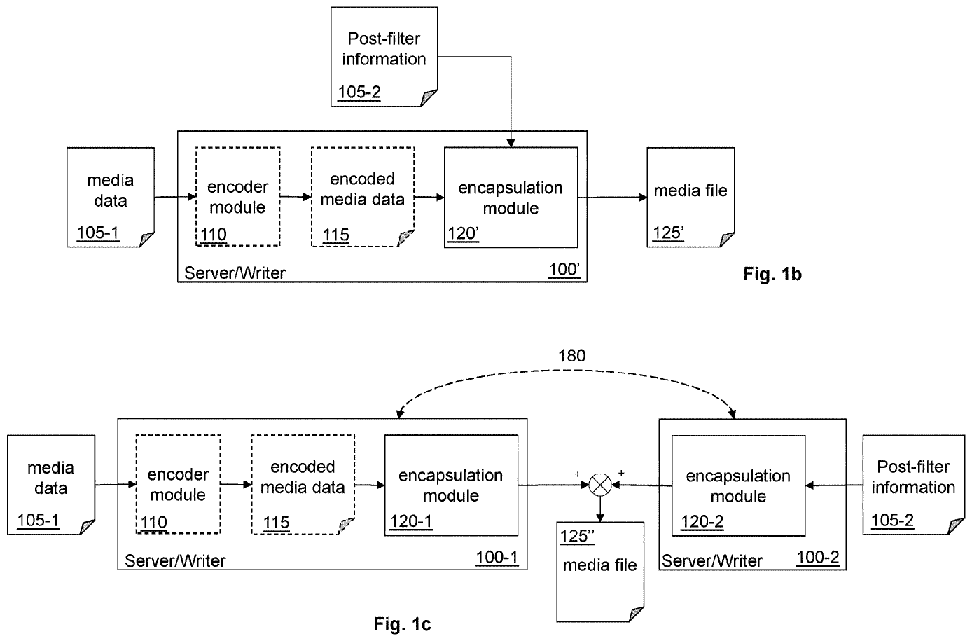

FIGS. 1a, 1b, and 1c illustrate an overview of a method for encapsulating or storing multimedia presentations according to some embodiments of the invention. The media data to be encapsulated or stored, referenced 105, can be video, spatial sub-part of a video, audio, volumetric visual media, subtitles, or a combination of such elementary streams. They are encapsulated into a media file or into media segment files 125 in a way that allows adaptive streaming over HTTP, possibly with low latency. As illustrated, a server 100 comprises an encapsulation module 120 (also called ISOBMFF writer or simply writer) and optionally a streaming manifest generation module, not represented. The server 100 may be connected, via a network interface, not represented, to a communication network 130 to which is also connected, via a network interface, not represented, a client 150. An example of client is a media player on a PC, in a tablet, in a TV, in a smartphone or in a virtual reality headset.

Server 100 processes media data 105 to prepare it for streaming or for storage, this is called encapsulation. It mainly consists in adding metadata describing the media data in terms of kinds of data, codec in use, size, data offsets, timing, etc. As mentioned above, media data 105 may correspond to audio presentation or video presentation of both, possibly with subtitles or timed text. Media data 105 may be the raw data captured by sensors or generated by a content creator or editing tools. Media data 105 may be available as compressed or encoded media data 115, possibly according to different encoded versions. This means that the encoding or compression may be performed by the server itself with an encoder module like encoder module 110 (possibly one per media type) or remotely from the server. The compression may be live encoding (as well as the encapsulation).

Media data 105 may also be encapsulated media data, these media data being encapsulated in a way that is not suitable for low-latency streaming, for example as non-fragmented tracks. In the latter case, the encapsulation module (e.g. encapsulation module 120) also contains a reader part to de-encapsulate the media data and then encapsulate de-encapsulated media data, according to some embodiments of the invention.

According to the illustrated example, encapsulation module 120 of server 100 is used to encapsulate the media data into movie fragments, for example according to ISOBMFF and its extensions (e.g. CMAF, NAL-unit based File Format, etc.). Server 100 then generates a media file referenced 125 or one or more segment files 125. The server 100 may optionally generate a streaming manifest like a DASH MPD or HLS playlist (not represented). The generated file, segment files, or manifest may be stored in a remote storage device, for example in a remote storage device accessible through network 140, for redistribution via on-demand or live streaming.

According to some embodiments of the invention, encapsulation module 120 generates an encapsulation file (or segments) allowing low-latency and adaptive streaming over HTTP.

Client 150 is used for processing data received from communication network 130, or read from a (local or remote) storage device, for example for processing media file or media segments 125. The data may be streamed to the client, thus involving a streaming module (not represented) in charge of parsing a streaming manifest, of determining requests to fetch the media streams, and of adapting the transmission, according to indication in the manifest and client parameters like for example available bandwidth, CPU, application needs, or user preference.

The received data is de-encapsulated in de-encapsulation module 160 (also known as a ISOBMFF parser, ISOBMFF reader, or simply parser or reader), the de-encapsulated data (or parsed data) may be decoded by a decoding module for storage display or for output to an application or to user(s). The decoder module (possibly one or more per media type) may be part of the client, may be an external module, or may be a dedicated hardware. The de-encapsulated data may correspond to encoded media data 165 (e.g. video bitstream, audio bitstream, etc.).

The de-encapsulation, decoding, and rendering may be live operations processing the media file as soon as it is received, for example by processing data chunks for each media stream in parallel and in synchronization to minimize the latency between the recorded multimedia presentation (as media data 105) and its visualization by user(s) as media data 175 for example onto his/her device's screen.

Client or server may be user devices but may also be network nodes acting on the media files being transmitted or stored. Server or client may only contain, respectively, the encapsulation and de-encapsulation parts.

It is noted that media file 125 may be communicated to client or reader 150 in different ways. In particular, server or writer (or packager) 100 may generate media file 125 with a media description (e.g. a DASH MPD) and communicate (or stream) it directly to client 150 upon receiving a request from client 150. Media file 125 may also be downloaded, at once or progressively, by and stored in client 150.

For the sake of illustration, media file 125 may encapsulate media data into boxes according to the ISO Base Media File Format (ISOBMFF, ISO/IEC 14496-12) and its derived specifications (e.g. Carriage of NAL unit structured video in the ISOBMFF, ISO/IEC 14496-15 or Common Media Application Format, CMAF ISO/IEC 23001-19) for example. In such a case, media file 125 may correspond to one or more media files (indicated in a FileTypeBox (‘ftyp’) box or in a SegmentTypeBox (‘styp’) box). According to ISOBMFF, media file 125 may include two kinds of boxes, one or more “media data boxes” (e.g. ‘mdat’ or ‘idat’ or ‘imda’ boxes), containing the media data, and “metadata boxes” (e.g. ‘moov’ or ‘moof’ boxes) containing metadata defining placement and timing of the media data and more generally providing description information on the media data. The media file or segment files contain movie fragments. The media data box(es) contain all the data of media data 105 or encoded media data 115. There may be one media data box multiplexing media data but there may also be one or more media data boxes, for example one per media type and possibly one or more per movie fragment. There may be variants in the system configuration, especially on the encapsulation side as depicted on FIG. 1b or FIG. 1c. On FIG. 1b, the encapsulation module may encapsulate the post filtering information 105-2 within the media file 125′ after the initial media data has been encapsulated. This post filtering information 105-2 may be for example computed after the media data 105-1 has been encoded or compressed by encoder module 110. On FIG. 1c, there may be several encapsulation modules encapsulating media data 105-1 and post-filter information 105-2 in the media file 125″. Still for the example, the server or writer for media data 105-1 and the server or writer for post-filter information 105-2 may be distinct entities (e.g. software modules on different devices), each encapsulating media data and post-filter information, respectively into the media file 125″. Note that server 100-2 may also contain an encoder or compression module (not depicted), for example an MPEG-7 Part-17 encoder to produce an efficient representation of a neural network model used for the post-filtering. The media file 125″ may also consist in a concatenation of media files generated by writer 100-1 on the one hand and of a media file generated by writer 100-2 on the other hand. According to some embodiments, the two writers may share common setup information, for example the knowledge of information that is written in the ‘moov’ box, like the initial track or sample configurations, as suggested with reference 180.

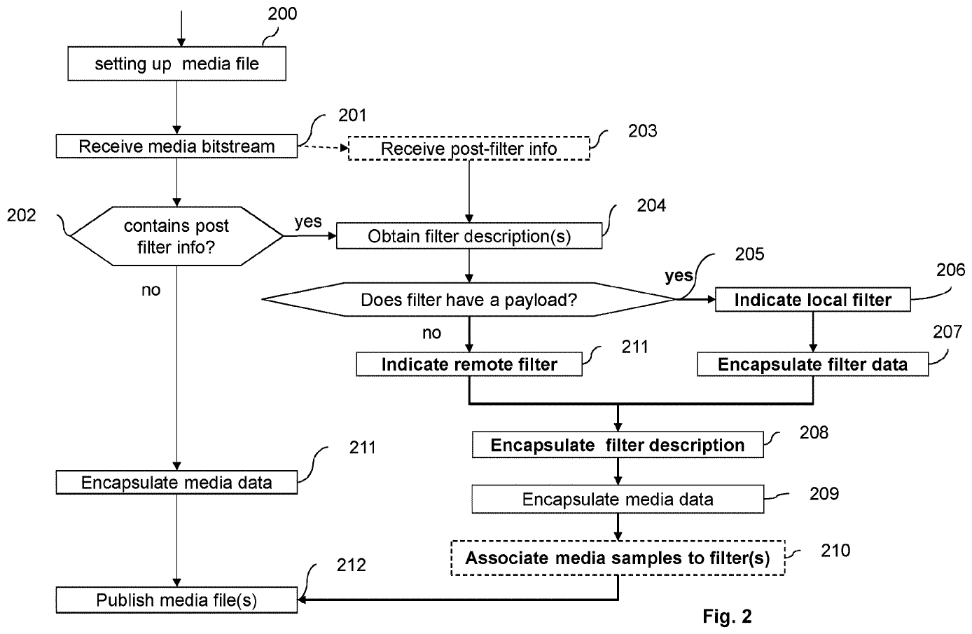

FIG. 2 illustrates the main steps of an encapsulation process according to embodiments of the invention. This is done by the encapsulation module 120 of FIG. 1 or encapsulation modules 120-1 and 120-2 on FIG. 1c. The process starts in step 200 by configuring the server 100 and optionally server 100-1. Configuration may concern encapsulation module 120, 120′ or 120″ and encoder module 110 or encapsulation module(s) only if encoder settings cannot be controlled, for example in the case where the configuration is hard-coded. For the sake of illustration, the configuration step may consist in indicating whether the media file will consist in a single file or in multiple segment files. The configuration may consist in defining the granularity of random access in the presentation (for example, every second or every 2 seconds . . . ) and possibly, for streaming application the switching points and addressable objects in the presentation (for example: a DASH media segment, a CMAF segment, CMAF fragment or CMAF chunk). The configuration may consist in indicating whether the post-filter information is to store within the media track or in another entity (e.g., an item, a track, a group of tracks or an entity group).

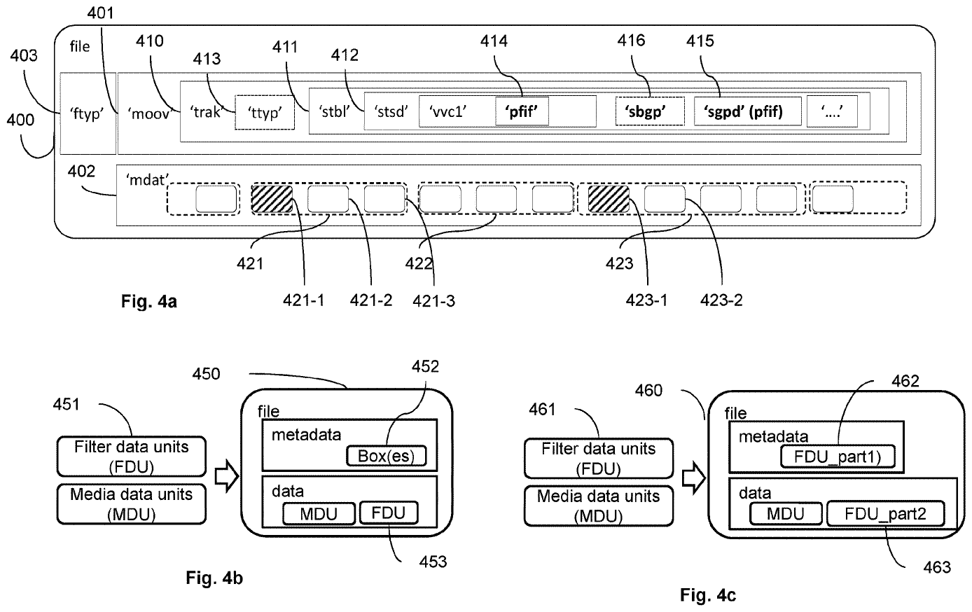

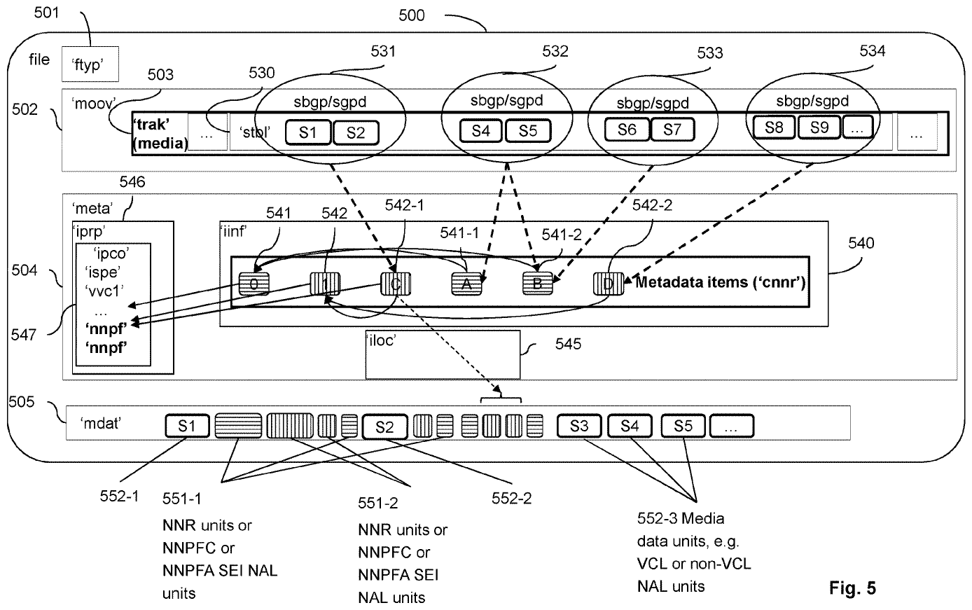

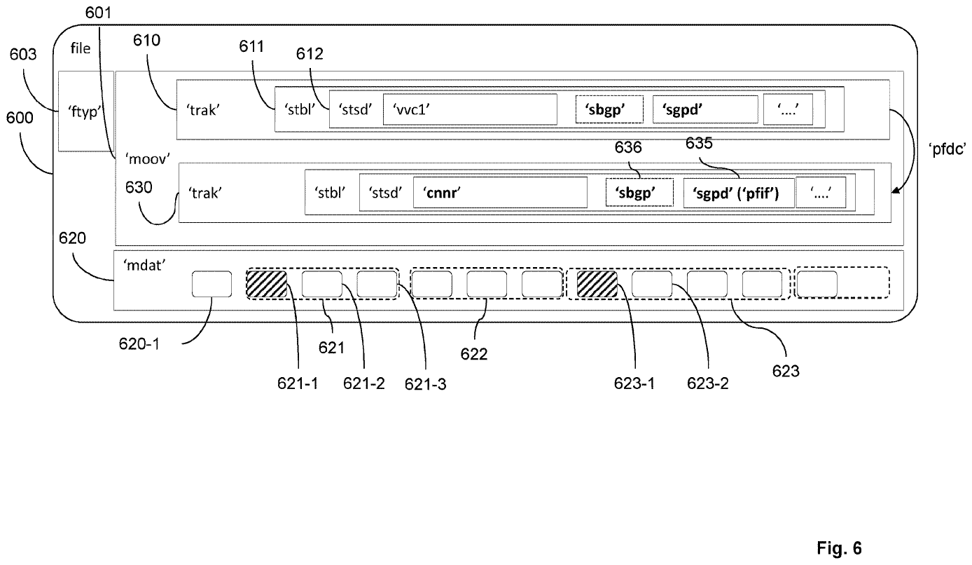

At step 201, the encapsulation module receives the compressed or encoded media data, the media bitstream. Then, it inspects if the bitstream contains or embeds post-filter information in 202. This may consist in looking for SEI NAL unit types in the bitstream and parsing the payload type of the detected SEI NAL units. If the payload type corresponds to a post-filter SEI message, then the encapsulation module moves to step 204. Otherwise, the encapsulation consists in encapsulating the media data the traditional way in a step 211. As an alternative to SEI messages in the bitstream, post-filter information (like 105-2) may be provided by other means (e.g., as a separate bitstream or as configuration information . . . ), as illustrated by step 203. At step 204, from SEI or from external post filter information, the encapsulation module determines a description of the filter. The description may contain for example the type of filter (e.g. neural-network based or a simple matrix of coefficients or any other representation), the purpose of the filter (e.g., increase resolution of images, increase temporal resolution, improve signal quality . . . ). Next, step 205 consists in checking whether the filter description contains a payload or not. For example, the NNPFC SEI message may embed an ISO/IEC 15938-17 bitstream (for example when the nnpfc_mode_idc parameter equals 0). This determination may depend on the representation format of the post-filter information or may be provided in the post-filter information received in 203. If a payload is present, test 205 true, the encapsulation module stores this information in the filter description in 206. Otherwise, the encapsulation module stores in the filter description that its payload is external to the file in step 211. Step 206 is followed by step 207 during which the encapsulation module stored the filter payload in data part of the media file. Different strategies to store this payload are described later on (item data as on FIG. 5, track samples as on FIGS. 4a, 4b, and 4c or 6, sample entries, sample groups . . . ). Step 208 consists in generating and storing the filter description in metadata part of the media file. It is to be noted that steps 206 and 207 can be done in any order. In the case of FIG. 1c, they can even be handled by different encapsulation modules. Then, media samples are encapsulated in 209 and optionally, filter information may be associated with samples in 210. By default, the post-filtering information may be associated at track level instead of sample level. These operations are iterated over samples present in the media bitstream and finally the media file is published for later use (storage, streaming, playout, sending . . . ).

The published media file according to the invention differs from a classical ISO Base Media File in the fact that it may contain additional metadata indicating that a media track may be further post-filtered, for example to improve its rendering. Without the invention, the media track may be seen as, for example a video track, an audio track and the application may not be aware that some post-filter instructions are present, possibly offering an improved rendering of the media track or at the reverse allowing the application to decide to skip the post-filtering by eventually discarding the post-filter information when reconstructing the media bitstream.

While described for one track, the encapsulation process may apply to multiple bitstreams, each bitstream having its own post-filter information or some bitstreams sharing a common post-filter information. It can also apply to a bitstream containing multiple post-filter information.

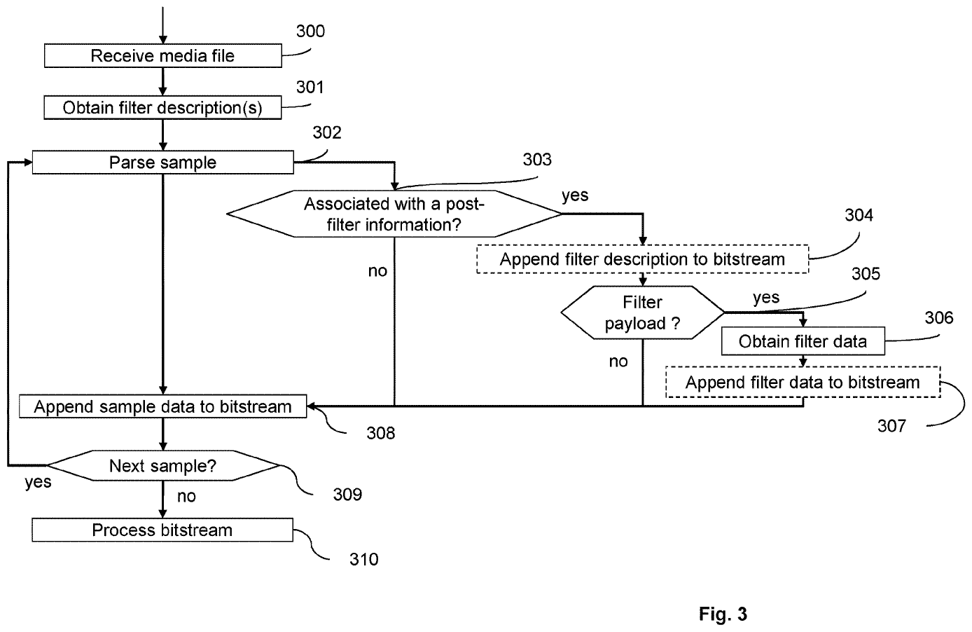

FIG. 3 illustrates the main steps of a parsing or reading process according to embodiments of the invention. The client may also be called “application” or “media player” (or renderer). The process starts by player initialization in step 300. The player receives a media file or media segments files, possibly with a manifest file, generated according to embodiments of the invention. The player is initialized with information obtained by requesting or reading an initialization segment or the beginning (e.g. first bytes) of a media file. When the media file is stored on a remove server, the URL or byte range for initialization data may be obtained from a manifest file like DASH MPD or a playlist for HTTP Live Streaming. Depending on the media file, whether it contains indication for post-filtering or not (test 301) the player may know the kind of media present in the media presentation, the codecs in use, etc. . . . and select a version it can decode and render. The step 301 consists in obtaining the filter description. It may be obtained from a dedicated box in the track or in the sample description (as further described later on FIGS. 4a, 4b, and 4c to 6). When the media file contains post-filtering information, the parser needs to check whether the post-filtering has been indicated as mandatory by content creator when packaging the media presentation or has been set as optional to render the media track (this may also be a configuration set by the encapsulation module from an application server). This puts some requirements on players: if it cannot identify the post-filter or support it, it may not select the track and indicate to an application that this media format is not supported. At the reverse, if it can support and process the post-filter information, the player can select the track and indicate to the application that the media type of this track is supported. When the track is selected, the parser starts processing samples at 302. It checks if a current sample is associated with post-filter information in 303. It can be determined from the metadata structure of the media file that may be contained in the track description or in the sample description or in dedicated metadata structure. It may also be contained in another entity when post-filter information is not stored within the media track. In case no post-filter information is associated with the sample (test 303 false), the parser extracts data corresponding to the sample and appends it to a reconstructed bitstream in step 308. The reconstructed bitstream, when no more samples are to be processed (309 false) is provided to an entity that will process it in 310, typically a media decoder. When the sample is associated with post-filter information (test 303 true), the parser may append in 304 the filter description to the reconstructed bitstream for the track. The filter configuration may be added in 304 if it defines a new configuration, if the sample is a synchronization sample or a random-access sample (e.g., allowing to start decoding from this sample) or if a different content is spliced to a first initial content. Then, the parser checks if the post-filter information contains a payload in the media file or not (test 305). If not the case, the data for the sample, possibly preceded by filter description is appended to the bitstream in 308. In the case of a video bitstream with SEI messages dedicated to post-filter information, this can be done by generating the appropriate SEI NAL units and inserting these SEI NAL units in the video bitstream. If payload is present, the parser obtains this payload in step 306 (e.g., from a media data box like ‘mdat’) and the payload may be appended to the bitstream in 307. Preferably, it is appended after the filter description, when present. The steps 302 to 308 are iterated until no more samples can be read from the track being parsed.

While described for one track, the parsing process may apply to multiple tracks present in a media file, each track having its own post-filter information or some tracks sharing a common post-filter information. It can also apply when a track contains multiple post-filter information.

### Generic Indication of Post-Filter Information

There may be different encapsulation modes for post-filter information: within the media track it applies to or in an external entity like a dedicated track or item or group of tracks or entity group. Whatever the encapsulation, there may be generic description worth indicating in the media file to inform players (or readers or parsers) that one or more media tracks come with post-filter information. This generic information is generated at encapsulation, for example from the SEI content in the case of video bitstream, or from the external post filtering information 105-2. These indications allow media players to detect presence of post-filter information, possibly with their purpose or complexity and can help players to decide whether to process or to skip the post-filtering.

### Generic Indication Through a Specific Brand

Defining a specific brand, to be used in ‘ftyp’ or ‘styp’ box, allows parsers to be informed that additional requirements related to post filtering exist to support the media file. This specific brand value may also be defined in a TrackTypeBox ‘ttyp’ to put additional requirements on the post processing of a specific track. In scope of this invention, for example a brand called “post-filter information present” and represented by the four-character code ‘pfip’ would inform parsers that some media tracks in a media file (or segment file) may contain or may be related to post-filter information, and that there may be alternative reconstruction for this media track: with or without application of the post-filter information. This brand may be declared in the list of compatible brands. This brand may be combined with metadata structures used to indicate the post-filter information associated with a media track. It may also inform parsers that an additional decoder to the one corresponding to the media type of a track may be required to decode the post-filter information of this track.

In the following, different embodiments of the invention are described. In all these embodiments post filter information is stored in the metadata part of the media file while payloads, for example of NNPFC or NNPFA SEI messages describing models, when provided, are stored in the data part of the media file. According to a first embodiment, post filter information is stored in the metadata part of the media track the post filter information applies to. According to a first variant of the first embodiment, post filter information is provided either in a static track sub-box or in a sample entry. According to a second variant of the first embodiment, post filter information in a static track sub-box or in a sample entry is completed with codec specific information. According to a third variant, post filter information is provided in sample group boxes describing group of samples to which the post filter information applies. In a second embodiment, post filter information is provided as metadata items associated with the media track the post filter information applies to. In a third embodiment, post filter information is provided in a metadata track associated with the media track the post filter information applies to.

### Generic Post-Filter Information in Metadata of the Media Track

According to the first variant of the first embodiment, the generic information for post-filter information may first indicate that a track contains or is associated with post-filter information. For example, we call this indication post_filter_presence. It can be a binary value. Then, a second field or parameter may indicate if the filter data or filter payload is provided in the media file or rather in an external file. For example, we call this indication post_filter_without_payload or post_filter_external_payload. Optionally, an additional parameter could provide the type of the payload, for example using a four-character code unambiguously identifying (for example recorded in a registration authority) the representation format of the post filter data or a universal resource identifier (URI) or a universal resource name (URN). Optionally, further description of the payload can be indicated like a size in bytes. Depending on this size, a parser may decide to fetch it or not when the payload is external or to use it or not when the payload is within the file considering latency aspect (e.g. fast startup or seeking). When applied to the NNPFC SEI message defined in Versatile SEI specification, it may correspond to the nnpfc_tag_uri parameter. This parameter may be set even if the payload is not in the media file. Another parameter for post-filter information can be the purpose of the filter. For example, it may improve the quality of a media track, it may increase resolution for a sequence of frames in a video track or increase the frame rate. For example, we call this parameter post_filter_purpose. There may be another parameter indicating whether the post filter information is coming from the same bitstream as the bitstream representing the media data or not. For example, we call this parameter post_filter_same_origin or post_filter_same_bitstream. Another possible parameter may be an indication on whether the filter description changes over time or not (i.e., remains the same along the track duration or not), or in other words is dynamic (can be updated) or static. For example, we call such parameter post_filter_update. Yet another parameter may be defined in a generic description of post-filter information: a post_filter_identifier. This parameter may be useful in case a media track relates to several filters, either along time or onto different parts of the samples. Such identifier allows associating samples with one or another filter or to multiple samples when needed. For example, in a video track, a first filter may be used on luminance component of a decoded sample and a second filter onto chrominance component of this decoded sample. Another parameter may be an indication of a target usage, for example is it to improve rendering by a user? Or is it to improve machine processing of the media track? Is it intended to both? Pre-defined values may be used to indicate the intended usages of the filtered output sample arrays resulting from the post-processing filter. Another parameter may provide a description of requirements in terms of complexity of the post-filter, for example memory requirement, the delay it may introduce in terms of samples, displaying latency, a number of operations to perform . . . .

These parameters may be grouped into a box dedicated to post-filter description. For example:

A post-filter information box provides a description of post-filter information associated with a track. It is identified by the four-character code ‘pfif’ for “Post-filter information” (like 414 on FIG. 4a). It may be contained in a sample entry as an optional box. When not present, it means that the samples referencing this sample entry do not have any associated post-filter information. Alternatively, when the encapsulation module can determine that it is static information, this box may be in the track description, as a sub-box of ‘trak’ box 410 in FIG. 4a. When not present, it means that no samples of this track have associated post-filter information.

An example of definition of the box may be summarized as follows:
BoxType: ‘pfif’
Container: Sample Entry or TrackBox or MetaBox
Quantity: Zero or more

The PostFilterInformationBox contains a description of post-filter information that may apply to samples of a track. It is to be noted that a subset of the possible parameters listed above is illustrated in the examples below, any of these parameters could be included in the metadata structures proposed hereafter.

The syntax of the box may be expressed as follows (the names of the parameters and the four-character code ‘pfif’ are just examples):

### Syntax

| aligned(8) class PostFilterInformationBox extends Box(‘pfif’) | |
|---|---|
| { | |
| unsigned int(1) post_filter_presence; | |
| unsigned int(7) reserved_bits; | |
| if (post_filter_presence) { | |
| unsigned int(1) | post_filter_without_payload; |
| unsigned int(1) | post_filter_same_bitstream; |
| unsigned int(1) | post_filter_update; |
| unsigned int(5) | post_filter_purpose; |
| utf8string | post_filter_identifier; |

}
}

In a variant where the presence or absence of this box can be used to respectively determine that some samples in a track may have associated post-filter information or not, the parameter for post_filter_presence can be omitted, thus simplifying the syntax as follows:

| aligned(8) class PostFilterInformationBox extends Box(‘pfif’) | |
|---|---|
| { | |
| unsigned int(1) | post_filter_without_payload; |
| unsigned int(1) | post_filter_same_bitstream; |
| unsigned int(1) | post_filter_update; |
| unsigned int(5) | post_filter_purpose; |
| utf8string | post_filter_identifier; |

}

While the above syntax examples are defined as inheriting from a Box, they could also inherit from a FullBox, thus providing the additional version and flags parameters for possible extensions or parameterization. It is to be noted that more bits may be allocated to the field indicating the purpose of the post-filter if there is a long predefined list registered in some registration authority (e.g. mp4 registration authority) or standard specification for post-filter description (e.g. V-SEI)

In a variant to handle both static and dynamic configurations with a same metadata structure, a post filter information is rather indicated as an entry in a sample group description box (‘sgpd’) like illustrated on FIG. 4a, box 415. For example, for post-filter information applying to a video track, the sample group description entry possibly contained in a sample group description box with grouping_type=‘pfif’ can be defined as follows, in such case the parameter indicating static or dynamic post-filter information is not needed. A SampleToGroupBox (‘sbgp’) box 416 with same grouping_type=‘pfif’ may be used to map samples onto the different entries of the ‘sgpd’ box:

class PostFilterSampleGroupEntry extends VisualSampleGroupEntry
(‘pfif’)
{

| | |
|---|---|
| unsigned int(1) | post_filter_without_payload; |
| unsigned int(1) | post_filter_same_bitstream; |
| unsigned int(5) | post_filter_purpose; |
| unsigned int(1) | reserved; |
| utf8string | post_filter_identifier; |

}

The semantics for the parameters describing post-filter information in a generic way are as follows:

post_filter_presence indicates, when equal to 1, that some samples referencing a sample entry containing this box have post-filter information associated. When used in a sample group description entry, it applies to samples mapped to this entry. When equal to 0; it indicates that no samples referencing a sample entry containing this box or no samples mapped to the sample group description entry contain post-filter information. The default value may be assumed to 1.

post_filter_without_payload indicates, when equal to 1, that no payload describing the post-filter data is available for some samples referencing a sample entry containing this box, or for some samples mapped to this sample group description. When equal to 0, it indicates that for some samples referencing a sample entry containing this box, or for some samples mapped to this sample group description entry, a payload describing the representation of the post-filter information is available in the data part of the media file. The default value may be assumed to 1. When applied to video tracks with NNPFC SEI message, the value of this parameter may correspond to the value of the nnpfc_mode_idc parameter.

post_filter_same_bitstream indicates, when equal to 1, that for some samples referencing a sample entry containing this box, or for some samples mapped to this sample group description entry, the post-filter description and possibly its payload (depending on the value of post_filter_without_payload) was present as data units (e.g., NAL units for MPEG video codecs) for the media track. In other words, it is an instruction to parsers or readers to include the post-filter information in the reconstructed bitstream for these samples if they decide that to render a post-filtered version of the media presentation. When equal to 0, it indicates that no post-filter description was contained in the data units for samples referencing a sample entry containing this box, or for some samples mapped to this sample group description entry. The default value may be assumed to 1. For example, on FIG. 4a, the media data is mixing within a given sample (for example 421 or 423) data units related to post-filter information in 421-1 and 423-1 (for example as SEI NAL units) with data units for media samples (for example VCL NAL units 421-2, 421-3 or 423-2, etc. . . . ). Some samples like 422 may not contain any data units corresponding to post filter data or payload.

post_filter_purpose is a value indicating the purpose of the post-filter applying to samples referencing a sample entry containing this box, or applying to samples mapped to this sample group description entry. When applied to video tracks with NNPFC SEI message, the value of this parameter may correspond to the nnpfc_purpose parameter. The pre-defined list of values to be used in this parameter may be media specific, for example one list of value per handler type (video, audio, text, volumetric, etc. . . . ).

post_filter_identifier is an identifier for the post-filter. When applied to video tracks with NNPFC SEI message, the value of this parameter may correspond to the nnpfc_id parameter. While represented as a string in the above structures, it may also be represented by an integer value, for example on 32 bits, or as a universally unique identifier (uuid) on 128 bits. It may identify a single filter or a group of filters to be applied to a sample or group of samples or to an item or group of items.

In this embodiment for a metadata structure describing post-filter information within the media track, the sample group approach is preferred as it allows to handle default, static or dynamic configurations of post-filter information by setting appropriate values in the flags or versions of the Sample Group Description Box (‘sgpd’) having a grouping type for post-filter indication (e.g., ‘pfif’ grouping_type).

Post-Filter Information in Metadata of the Media Track Possibly with Codec Specific Information

According to the second variant of the first embodiment, the metadata structures defined in the previous embodiment to embed post-filter information in a media file may be enriched by additional parameters allowing to consider post filter information according to specific representation format, like the NNPFC SEI message of the Versatile-SEI specification. A first variant may consist in allocating a pre-defined number of bits to convey codec-specific parameters, as follows:

```
aligned(8) class PostFilterInformationBox extends Box(‘pfif’)
{
  unsigned int(1) post_filter_without_payload;
  unsigned int(1) post_filter_same_bitstream;
  unsigned int(1) post_filter_update;
  unsigned int(5) post_filter_purpose;
  unsigned int(32) post_filter_codec_specific;
}
```

The codec specific parameter may be controlled by a flag (not represented in above syntax) indicating whether it is present or not, to save 32 bits when no codec-specific information is available. Another variant would consist in indicating a size of the codec-specific information and then indicate this information as a sequence of bytes.

```
aligned(8) class PostFilterInformationBox extends Box(‘pfif’)
{
  unsigned int(1) post_filter_without_payload;
  unsigned int(1) post_filter_same_bitstream;
  unsigned int(1) post_filter_update;
  unsigned int(5) post_filter_purpose;
  unsigned int(16) post_filter_codec_specific_length;
  int size = 0;
  while (size < post_filter_codec_specific_length){
    unsigned int(8) post_filter_codec_byte;
    size ++;
  }
}
```

These two variants could apply to the ‘pfif’ box or to the sample group description entry ‘pfif’.

The semantics corresponding to the post_filter_codec_specific parameter or to the post_filter_codec_byte parameter is defined as follows:

This parameter provides additional information related to post-filtering that is codec specific (i.e., may not be understandable by generic ISOBMFF parsers and requires to support additional specification). For example, for video tracks embedding SEI message(s) for neural network-based post filtering (e.g., NNPFC or NNPFA), the encapsulation module may copy some elements from the syntax of the NNPFC SEI message in this codec specific parameter. It is to be noted that even if the post_filter_without_payload equals 0, only elements from the syntax may be copied in the post_filter_codec_specific or post_filter_codec_byte but no data corresponding to payload. This is to avoid having important description sizes for metadata structures. This means that an SEI message providing post-filter information may be split in two parts: one description part and one payload part and only the description part may be stored in the codec specific parts of the metadata structure indicating post-filter information. In such case, data units 421-1 and 423-1 in the data part of the media file and described below in relation with FIG. 4a, may correspond to post-filter payload only (and no more to the complete SEI data unit). This also means that when the post_filter_same_bitstream parameter is equal to 1, the parsers may reconstruct a bitstream using the part of the SEI syntax from the metadata structure indicating post-filter information and moreover, when post_filter_without_payload is equal to 0, using part of the data corresponding to the payload of the SEI message.

post_filter_codec_specific_length indicates the number of bytes present in the metadata structure to indicate codec specific parameters for post-filter information.

### Mapping Post-Filter SEI Message in Metadata of a Media Track

According to the third variant of the first embodiment, a metadata structure is created by encapsulation module to indicate in media files information about post-filter information to be used with media data. These indications allow media players to detect presence of post-filter information, possibly with their purpose or complexity and can help players to decide whether to process or to skip the post-filtering. Some indication may constrain players to process the media track with the post-filter instructions, thus impacting the track selection at player side. For example, in case of a VVC encoded video bitstream, NNPFC and NNPFA SEI messages may also be embedded in this VVC bitstream. An amendment to NAL unit-based File Format is considering using sample groups to convey the NNPFC and NNPFA messages. However, their current definition also embeds the payload of the NNPFC when present in the SEI message. Moreover, the proposed sample groups simply copy the SEI NAL units for the NNPFC and NNPFA SEI messages in sample group description entries. This does not provide any indication to generic parsers about the post filtering (purpose, in file or external, etc. . . . ) and requires parsers to implement the parsing of these NNPFC and NNPFA SEI messages. The mapping of NNPFC and NNPFA is different here because a high-level and generic description of the post-filter is provided (without requiring parsing of the SEI messages) and it proposes to keep the payload part in the data part of the media file. This avoids having too important amount of data in the metadata part of a media file by keeping the SEIs in the data. The post-filter information may be provided for example as sample groups with sample group description entries that contain a description of the post-filter rather than the NNPFC or NNPFA SEI NAL unit(s).

The current design for the Neural-network post-filter activation sample group suffers from a limitation when several updates are available. Current activation SEI may allow to activate, cancel or re-activate an update that corresponds to the latest encountered update. Indeed, activation only contains a target identifier of a NNPFC, but no indication of an update version. The NNPFA SEI message could then be improved to contain, in addition to the identifier of the target neural-network post-processing filter, an update index thus allowing to re-activate a given update by using this index.

An example syntax for the NNPFA SEI message handling different update versions could be:

| | Descriptor |
|---|---|
| nn_post_filter_activation( payloadSize ) { | |
| nnpfa_target_id | ue(v) |
| nnpfa_update_version | ue(v) |
| nnpfa_cancel_flag | u(1) |
| if( !nnpfa_cancel_flag ) { | |
| nnpfa_persistence_flag | u(1) |
| } | |

Where nnpfa_update_version indicates an index of updates for the NNPFC model identified by nnpfa_target_id. The default value, when applying to base or when no update is available is 0. This may improve NNPFA SEI messages by allowing to cancel or activate any configuration of a given post-filter: either the base or any update, while initial current design seems to consider the most recent update, if any.

It is proposed a sample group to convey information about neural network-based post filter characteristics (NNPFC sample group) and a sample group to convey information about neural network-based post filter activation (NNPFA sample group).

All instances of the SampleToGroupBox for the NNPFC sample group shall include a grouping_type_parameter. The grouping_type_parameter field is specified for the NNPFC sample group as follows:

```
{
  unsigned int(1) filter_update_flag;
  unsigned int(31) filter_id;
}
```

Where filter_update_flag equal to 1 indicates that all the sample group description entries referenced by this SampleToGroupBox contain an NNPFC SEI message that provides an update on top of a base post-processing filter. filter_update_flag equal to 0 indicates that all the sample group description entries referenced by this SampleToGroupBox contain an NNPFC SEI message that specifies a base post-processing filter.

filter_id indicates that all the sample group description entries referenced by this SampleToGroupBox contain an NNPFC SEI message that has nnpfc_id (identifier of the neural network model in use) equal to filter_id.

When a sample is not mapped to NnpfcSeiSampleGroupEntry in a SampleToGroupBox having filter_update_flag equal to 0 and a particular filter_id, the sample shall not be mapped to an NnpfcSeiSampleGroupEntry in a SampleToGroupBox having filter_update_flag equal to 1 and the same filter_id.

When a track contains an NNPFC sample group, no NNPFC SEI messages shall be present within the sample entries of the track. When a VVC track has an associated VVC non-VCL track that contains an NNPFC sample group, no NNPFC SEI messages shall be present within the samples or sample entries of the VVC track and no NNPFC SEI messages shall be present within the sample entries of the VVC non-VVL track.

When a reader supports the NNPFC sample group, it shall perform the following insertion of prefix SEI NAL units as a part of the bitstream reconstruction:
When a sample is mapped to at least one NnpfcSeiSampleGroupEntry with filter_update_flag equal to 0 and the sample is
   a sync sample, or
   the first sample of a sequence of samples associated with the same sample entry, or
   the first sample of a group of samples mapped to the same NnpfcSeiSampleGroupEntry with filter_update_flag equal to 0 and a particular filter_id value filterIdBase,

then the sample implicitly contains a prefix SEI NAL unit for each layer contained in the track and each filter_id value mapped to the sample, and the prefix SEI NAL unit contains the NNPFC SEI message from the data for the first sample mapped sample with filter_update_flag equal to 0, followed by the NNPFC SEI message from the NnpfcSeiSampleGroupEntry with filter_update_flag equal to 1 and filter_id equal to filterIdBase that is mapped to the sample, if any.
When a sample is the first sample in a sequence of samples mapped to the same NnpfcSeiSampleGroupEntry with filter_update_flag equal to 1 and a particular filter_id value filterIdUpdate and the sample is
   not a sync sample, and
   not the first sample of a sequence of samples associated with the same sample entry, and
   not the first sample in a sequence of samples mapped to the same NnpfcSeiSampleGroupEntry with filter_update_flag equal to 0 and filter_id equal to filterIdUpdate,

then the sample implicitly contains a prefix SEI NAL unit for each layer contained in the track and each filter_id value mapped to the sample, and the prefix SEI NAL unit contains the NNPFC SEI message from the NnpfcSeiSampleGroupEntry with filter_update_flag equal to 1.

The syntax for a NNPFC sample group description entry may be as follows:

```
aligned(8) class NnpfcSeiSampleGroupEntry( ) extends
VisualSampleGroupEntry(‘nfcs’)
{
  unsigned int(8) nnpfc_sei_id; // to map authorized values for
nnpfc_id, could be described on 32 bits to align to NNPFC SEI
  unsigned int(1) nnpfc_update; // if not first occurrence of this
id
  unsigned int(1) nnpfc_external_payload;
  unsigned int(1) nnpfc_purpose;
  unsigned int(1) nnpfc_complexity_info_present_flag;
  if (nnpfc_complexity_info_present_flag) {
    unsigned int(32) nnpfc_num_kmac_operations_idc;
    unsigned int(32) nnpfc_total_kilobyte_size;
  }
}
```

with the following semantics:

nnpfc_sei_id contains an identifying number that may be used to identify a post-processing filter. The value of nnpfc_sei_id shall be in the range of 0 to 255, inclusive. This parameter could be omitted in the sample group description entry since it can be deduced from the value of grouping_type_parameter of the corresponding ‘sbgp’ box with grouping type ‘nfcs’.

nnpfc_update indicates when set to 1 that the corresponding post-processing filter is an update. When set to 0, it indicates a base model. This parameter could be omitted in the sample group description entry since it can be deduced from the value of grouping_type_parameter of the corresponding ‘sbgp’ box with grouping type ‘nfcs’. It should be present if the sample grouping to describe post-filter information does not use or define the grouping_type_parameter.

nnpfc_external_payload indicates, when set to 1, that the payload for the post-processing filter is external to the file. When set to 0, the payload is present in the data part of the file.

nnpfc_purpose indicates indicates the purpose of the post-processing filter as specified in ISO/IEC 23002-7.

nnpfc_complexity_info_present_flag specifies whether one or more syntax elements that indicate the complexity of the post-processing filter associated with the nnpfc_id are present (when set to 1) or not (when set to 0).

nnpfc_num_kmac_operations_idc indicates the maximum number of multiply-accumulate operations per sample as specified in ISO/IEC 23002-7.

nnpfc_total_kilobyte_size indicates a total size in kilobytes required to store the uncompressed parameters for the neural network as specified in ISO/IEC 23002-7.

The sample group for activation of neural network-based post filter may then be defined as explained hereafter.

The neural-network post-filter activation (NNPFA) SEI message is specified in ISO/IEC 23002-7. NNPFA SEI messages may be included in a VVC bitstream.

An NNPFA SEI message contains the nnpfa_target_id syntax element, which is an identifying number that may be used to identify the post-processing filter that the NNPFA SEI message concerns.

An NNPFA SEI message indicates that the applicable post-processing filter with nnpfc_id equal to nnpfa_target_id may be used to filter the picture containing the NNPFA SEI message.

Instances of the SampleToGroupBox for the NNPFA sample group shall include grouping_type_parameter. The grouping_type_parameter field is specified for the NNPFA sample group as follows (the number of bits for each parameter could be different than 16 bit each, depending on the possible range of authorized values for each parameter, provided that the sum remains equal to 32 bits):

```
{
  unsigned int(16) filter_update_index;
  unsigned int(16) target_filter_id;
}
```

filter_update_index is an integer indicating that all the sample group description entries referenced by this SampleToGroupBox contain an NNPFA SEI message that concerns the filter_update_index-th update on top of a base post-processing filter. filter_update_index equal to 0 indicates that all the sample group description entries referenced by this SampleToGroupBox contain an NNPFA SEI message that applies to a base post-processing filter.

target_filter_id indicates that all the sample group description entries referenced by this SampleToGroupBox contain an NNPFA SEI message that has a target_nnpfa_id equal to target_filter_id

When a track contains an NNPFA sample group, no NNPFA SEI messages shall be present within the sample entries of the track.

When a reader supports the NNPFA sample group, it shall perform the following insertion of prefix SEI NAL units as a part of the bitstream reconstruction:
When a sample is mapped to at least one NnpfaSeiSampleGroupEntry, the sample contains a prefix SEI NAL unit for each layer contained in the track, and the prefix SEI NAL unit contains the NNPFA SEI message from the sample data.

When a reader processes an NNPFA sample group, it shall also process the NNPFC sample groups of the same track. When a VVC track has an associated VVC non-VCL track that contains an NNPFA sample group, no NNPFA SEI messages shall be present within the samples or sample entries of the VVC track and no NNPFA SEI messages shall be present within the sample entries of the VVC non-VCL track.

When an NNPFC sample group is an essential sample group and an NNPFA sample group is present in the same track, the NNPFA sample group shall be an essential sample group and the ‘esgh’ sample group shall list ‘nfcs’ and ‘nfas’ in subsequent entries of the sample_group_description_type array.

The syntax for a NNPFC sample group description entry may be as follows:

```
aligned(8) class NnpfaSeiSampleGroupEntry( ) extends
VisualSampleGroupEntry(‘nfas’)
{
  unsigned int(1) nnpfa_cancel_flag;
  if (!nnpfa_cancel_flag) {
    unsigned int(1) nnpfa_persistence_flag;
    unsigned int(6) reserved;
  }
  else
    unsigned int(7) reserved;
}
```

with the following semantics:

nnpfa_cancel_flag has the same semantics as defined in ISO/IEC 23002-7. Meaning that when equal to 1 it indicates that the persistence of the target neural-network post-processing filter established by any previous NNPFA SEI message with the same nnpfa_target_id as the current SEI message is cancelled, i.e., the target neural-network post-processing filter is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag has the same semantics as defined in ISO/IEC 23002-7. It specifies the persistence of the target neural-network post-processing filter for the current layer.

nnpfa_persistence_flag equal to 0 specifies that the target neural-network post-processing filter may be used for post processing filtering for the current picture only.

nnpfa_persistence_flag equal to 1 specifies that the target neural-network post-processing filter may be used for post processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

The target neural-network post-processing filter is not applied for this subsequent picture in the current layer associated with a NNPFA SEI message with the same nnpfa_target_id as the current SEI message and nnpfa_cancel_flag equal to 1.

Optionally, parameters corresponding to an identifier for the target post-filter and to the indication of base or update version could be inserted in a ‘nfas’ sample group description entry, especially if the sample group for post-filter information does not use or define the grouping_type_parameter.

In an embodiment for mapping NNPFC or NNPFA SEI messages to a VVC track, sample groups can be used to indicate the samples that contain SEI NAL units for these SEI messages. This means that samples are not mapped based on the filter activation: it is up to the application, from samples activating or cancelling a post-filter to determine which samples use which filter. This embodiment makes the bitstream reconstruction easier for parsers while providing enough information to deduce the active post filter configuration. For this the sample groups for neural network based post-processing filter characteristics and activation are described as explained hereafter.

A sample mapped to NnpfcSeiSampleGroupEntry contains one or more SEI NAL units corresponding to one or more NNPFC SEI messages. For each contained NNPFC SEI message, the sample group description indicates whether the sample contains the base post-processing filter or an update of the post-processing filter. The grouping_type_parameter field may not be specified for the NNPFC sample group

When a sample is not mapped to NnpfcSeiSampleGroupEntry, the sample does not contain any SEI NAL units for NNPFC SEI messages.

When a track contains an NNPFC sample group, no NNPFC SEI messages shall be present within the sample entries of the track. When a VVC track has an associated VVC non-VCL track that contains an NNPFC sample group, no NNPFC SEI messages shall be present within the samples or sample entries of the VVC track and no NNPFC SEI messages shall be present within the sample entries of the VVC non-VCL track.

A sync sample shall contain SEI NAL units corresponding to a NNPFC SEI message that is active on at least one sample from this sync sample to the next sync sample. A sync sample shall be mapped to a NnpfcSeiSampleGroupEntry

When a reader supports the NNPFC sample group, it shall perform for the mapped samples the insertion of prefix SEI NAL units corresponding to NNPFC SEI messages as a part of the bitstream reconstruction. The proposed syntax for the description of Neural network based post filter characteristics in a video track can be defined as follows:

```
aligned(8) class NnpfcSeiSampleGroupEntry( ) extends
VisualSampleGroupEntry(‘nfcs’)
{
  unsigned int(8) nnpfc_entries;
  for (int i=0; i < nnpfc_entries; i++) {
    unsigned int(32) nnpfc_sei_id;
    unsigned int(1) nnpfc_update;
    unsigned int(1) nnpfc_external_payload;
    unsigned int(5) nnpfc_purpose;
    unsigned int(1) nnpfc_complexity_info_present_flag;
    if (nnpfc_complexity_info_present_flag) {
      unsigned int(32) nnpfc_num_kmac_operations_idc;
      unsigned int(32) nnpfc_total_kilobyte_size;
    }
  }
}
```

with the following semantics:

nnpfc_entries indicates the number of NNPFC SEI messages contained in the samples mapped to this entry.

nnpfc_sei_id contains an identifying number that may be used to identify a post-processing filter as specified in ISO/IEC 23002-7.

nnpfc_update indicates whether the sample contains a base model of a post-processing filter or an update. Value 0 indicates a base model, value 1 indicates an update.

nnpfc_external_payload indicates, when set to 1, that the payload for the post-processing filter is external to the file. When set to 0, the payload is present in the data part of the file.

nnpfc_purpose indicates indicates the purpose of the post-processing filter as specified in Table 20 of ISO/IEC 23002-7.

nnpfc_complexity_info_present_flag specifies whether one or more syntax elements that indicate the complexity of the post-processing filter associated with the nnpfc_id are present (when set to 1) or not (when set to 0).

nnpfc_num_kmac_operations_idc indicates the maximum number of multiply-accumulate operations per sample as specified in ISO/IEC 23002-7.

nnpfc_total_kilobyte_size indicates a total size in kilobytes required to store the uncompressed parameters for the neural network as specified in ISO/IEC 23002-7.

In a variant, instead of a loop on the number of NNPFC SEI messages, the use of grouping_type_parameter could still be used to map a given samples on different sample group description entries, each entry containing one post-filter description (possibly with the set of parameters in the for loop in the above syntax or a subset of those. For example, the identifier and indication of update may not be repeated when it is available in the grouping_type_parameter).

The sample group to support the NNPFA SEI message may be redefined as follows:

A sample that is mapped to a NnpfaSeiSampleGroupEntry contains one or more SEI NAL units corresponding to a NNPFA SEI message.

A sample that is not mapped to a NnpfaSeiSampleGroupEntry does not contain any SEI NAL units corresponding to a NNPFA SEI message

A sync sample may contain SEI NAL units corresponding to a NNPFA SEI messages preserving the active configuration before the sync sample. A sync sample may be mapped to a NnpfaSeiSampleGroupEntry

Instances of the SampleToGroupBox for the NNPFA sample group shall include grouping_type_parameter. The grouping_type_parameter field is specified for the NNPFA sample group as follows:

```
{
  unsigned int(16) filter_update_index;
  unsigned int(16) target_filter_id;
}
```

Where filter_update_index is an integer indicating that all the sample group description entries referenced by this SampleToGroupBox contain an NNPFA SEI message that concerns the filter_update_index-th update on top of a base post-processing filter. filter_update_index equal to 0 indicates that all the sample group description entries referenced by this SampleToGroupBox contain an NNPFA SEI message that applies to a base post-processing filter. In a variant, this parameter may simply consist in a flag distinguishing between a base or an update but having this parameter rather as an index improves support of NNPFA SEI messages by allowing to cancel or activate any configuration of a given post-filter (either the base or any update, while current design seems to consider the most recent update, if any).

target_filter_id indicates that all the sample group description entries referenced by this SampleToGroupBox contain an NNPFA SEI message that has a target_nnpfa_id equal to target_filter_id

In a variant the grouping_type_parameter, instead of a filter_update_index, may simply use a flag to indicate whether the sample group description corresponds to a base or an update (assuming then the latest update). Optionally, parameters corresponding to an identifier for the target post-filter and to the indication of base or update version could be inserted in a ‘nfas’ sample group description entry, especially if the sample group for post-filter information does not use or define the grouping_type_parameter

When a track contains an NNPFA sample group, no NNPFA SEI messages should be present within the sample entries of the track.

When a reader supports the NNPFA sample group, it should perform, for the mapped samples, the insertion of the prefix SEI NAL units corresponding to NNPFA SEI message as a part of the bitstream reconstruction.

When a sample is mapped to at least one NnpfaSeiSampleGroupEntry, the sample contains a prefix SEI NAL unit for each layer contained in the track, and the prefix SEI NAL unit contains the NNPFA SEI message from the sample data.

When a reader processes an NNPFA sample group, it shall also process the NNPFC sample groups of the same track. When a VVC track has an associated VVC non-VCL track that contains an NNPFA sample group, no NNPFA SEI messages shall be present within the samples or sample entries of the VVC track and no NNPFA SEI messages shall be present within the sample entries of the VVC non-VCL track.

When an NNPFC sample group is an essential sample group and an NNPFA sample group is present in the same track, the NNPFA sample group shall be an essential sample group and the ‘esgh’ sample group shall list ‘nfcs’ and ‘nfas’ in subsequent entries of the sample_group_description_type array. The syntax for the sample group description entries describing the activation of post filters may be defined as follows:

| aligned(8) class NnpfaSeiSampleGroupEntry( ) extends | |
|---|---|
| VisualSampleGroupEntry(‘nfas’) | |
| { | unsigned int(1) nnpfa_cancel_flag; |
| | if (!nnpfa_cancel_flag) { |
| | unsigned int(1) nnpfa_persistence_flag; |
| | unsigned int(6) reserved; |
| | } |
| | else |
| | unsigned int(7) reserved; |

}

with the following semantics:

nnpfa_cancel_flag has the same semantics as defined in ISO/IEC 23002-7.

nnpfa_persistence_flag has the same semantics as defined in ISO/IEC 23002-7 In a variant, instead of using the grouping_type_parameter, a loop on the number of NNPFA SEI messages may be included in the sample group description entry of type nfas, in the same way as in the nfcs sample group description entry. For example, a parameter nnpfa_entries indicates the number of NNPFA SEI messages contained in the samples mapped to this entry.

As another variant, the grouping_type_parameter may be used to map samples to post filter activation or cancellation, for example by allocating bits from the grouping_type_parameter to indicate cancel/activate or 2 bits to reflect the possible values of cancel and persistence. In this variant, the sample group description entry may not repeat the cancel or persistence information. If grouping_type_parameter is only used for cancellation/activation indication, then the indication of post_filter identifier or post_filter_update may be declared in the sample group description entry ‘nfas’.

For parsers to easily locate the NAL units corresponding to NNPFC or NNPFA SEI messages in the mapped samples, an additional parameter may be provided in the sample group description entry nfcs and nfas providing the index or position of the NAL unit corresponding to a NNPFC SEI message and NNPFA SEI message respectively. The index starts from the sample offset, i.e. the first NAL units of a sample has index 1.

Alternatively, or in addition to any variants for sample groups providing post-filter information like sample groups with grouping_type ‘nfcs’ or ‘nfas’, the NNPFC or NNPFA SEI messages may be included in the list of important SEI messages from application point of view, using for example an ‘seii’ box.

Indication of Post-Filter Information within Media Track

FIG. 4a illustrates an example metadata structure indicating that post-filter information is available for a track in a media file. This corresponds to details of step 208 in the encapsulation process. It may be used in the parsing process described in FIG. 3, for example at step 303. There may be different ways of indicating in a media file that a track has related post-filter information, depending on the dynamicity of these information, on the granularity of the information.

FIG. 4a depicts an example of a media file 400 containing a media track 410 with associated post-filter information. The media file could contain multiple media tracks, but for the sake of clarity, only one is illustrated. The track 410 may be fragmented, this case is not illustrated here. The media file has a metadata part represented by the ‘moov’ box 401 and its sub-boxes 410, etc and a data part represented by the ‘mdat’ box 402. This data part contains data units (e.g., NAL units for MPEG video codecs) for a sequence of samples like 421, 422 or 423. A sample may contain data units for post-filter information 421-1 or 423-1, and data units for media data 421-2 or 421-3 or 423-2 . . . . The media file also contains an ‘ftyp’ box 403 possibly containing a brand indicating that some track has post-filter information present, for example as a ‘pfip’ compatible brand. This specific brand could alternatively be indicated in a TrackTypeBox like 413. The box 411 contains the sample table box (‘stbl’) providing the sample description and declaring sample entries in the ‘stsd’ box 412. For example, the ‘stsd’ 412 indicates that the track is a video track of type ‘vvc1’. Within the sample description, there may be a specific box like 414 or dedicated sample groups like 415 and 416 to indicate post filter information. The content of 414 may correspond to one of the variants in previously described embodiments, a PostFilterInformationBox as an optional box in a sample entry. The boxes 416 and 415 may correspond to one the variants in previously described embodiments, i.e., sample groups with a specific grouping_type (‘pfif’ on the FIG. 4a, or ‘nfcs’ or ‘nfas’ for the mapping of NNPFC and NNPFA SEI messages in the metadata part of a media track) mapping samples to a description of a post-filter. As illustrated on FIG. 4a, the description of the post-filter information may be in the metadata part but the payload remains in the data part represented by 421-1 or 423-1 data units or NAL unit in case of an MPEG video track. This avoids extracting data units from the bitstream when encapsulating this bitstream and to reinsert the same when parsing. The description part should allow parsers to determine whether they keep or skip post-filter related data units for the bitstream reconstruction. Smarts parsers to allow fast startup may decide to shift the insertion of data units for post-filter. For example, parsers may wait few samples to insert the post-filter related data units in the reconstructed bitstream instead of inserting it on the first or on the synchronization sample. The player may then start rendering the first video samples while obtaining post-filter information and applying it to following samples. This would result in a progressive improvement of the video quality with fast startup or fast tuning-in or seeking.

It is to be noted that there may be an advantage to combine metadata describing post-filter information at both sample entry, or track level, and sample group description. The former would allow players to be informed that additional processing to the media decoding could be required. This can be useful to instantiate appropriate decoders and to allocate resource (CPU or memory). For example, a type or a purpose of post-filter may be useful, as well as its availability in the file since it may induce delay when it is external. This could be described by a subset of the parameters of the PostFilterInformationBox. The sample group description level would provide finer information on which samples may be post-filtered and how (the payload to use).

On the sharing of description and payload for indicating post-filter information in a media track, there may be different approaches when considering the encapsulation of filter data units, as illustrated on FIGS. 4b and 4c:

FIG. 4b illustrates an embodiment where, for encapsulating filter data units 451 (FDU) and media data units (MDU), the media file 450 comprises a metadata part comprising boxes 452 which may be some of the generic descriptions or the V-SEI specific mapping described above (e.g., dedicated box or sample group). The media file 450 comprises in the data part a payload 453 consisting in filter data units without any modification, namely the filter data units 451. It is to be noted that there may be some overlap, meaning duplicated parameters, between metadata in 452 and FDU in 453.

FIG. 4c illustrates an embodiment where, for encapsulating filter data units 461 (FDU) and media data units (MDU), the media file 460 comprises a metadata part comprising boxes 462 that may include a part of the filter data unit 461, for example syntax elements describing the post-filter information. The media file 460 comprises in the data part a payload 463 that may consist in the payload part of the filter data units when present or the remaining part of the syntax elements describing the post-filter information plus the payload, when present. Data part may mix media data units and filter data units. It is to be noted that there may be some overlap, meaning duplicated parameters, between description data in the metadata part FDU_part1 462 and the payload and/or remaining syntax element in the data part FDU_part2 463.

It is to be noted that the two possibilities illustrated by FIGS. 4b and 4c may apply to all embodiments.

When post-filter information is provided in a sample group and when one post-filter information applies to a set of or all samples of a track, the default sample grouping may be used to avoid mapping the set of or all the samples to a sample group description entry.

When post-filter information is provided in a sample group and when all the post-filter information is known at the beginning of encapsulation or when it can be determined that no updates on post-filter information are foreseen along the media presentation (e.g., systems configuration or settings), then static sample group may be used.

### Indication of Post-Filter Information as Information Item

FIG. 5 illustrates an embodiment where the post-filter information is stored outside the media track it applies to. One benefit of this embodiment is to allow mutualization of post-filter information across several media tracks, if needed. In this embodiment, a media file 500 may contain a ‘ftyp’ box 501 that may embed a brand indicating the presence of post-filter information in the list of compatible brands. This brand may alternatively be indicated in a TrackTypeBox in a ‘trak’ box of a media track like 503, using post-filter information. The media file 500 contains a metadata part comprising a MovieBox 502 and its sub-boxes like 503 and a MetaBox 504 with their own hierarchy of boxes describing the media present in the file 500 with their associated post-filter information. The media file 500 also contains a media data part comprising one or more MediaDataBox(es) 505 to store data for track samples or items. As a reminder, tracks have been defined for encapsulation of timed media data where the media data are composed of samples to be rendered under a time constraint as, for example, video sequences. Items are defined for encapsulation of non-timed media data as, for example, still images. Similarly to tracks, items are composed of a metadata part comprising a description of the item stored in the metadata part 504 and associated with a media data part in the data part 505 of the media file. Metadata items are specific items characterized in that the data part of the items, stored in the data part 505 of the media file actually comprises metadata. In this embodiment, the MediaDataBox 505 may mix data for post-filter information like 551-1 or 551-2 and data for media samples like 552-1, 552-2, 552-3, etc. . . . . For example, when applied to MPEG video codecs like VVC and the neural network-based post filter SEI messages, 551-1 or 551-2 may be NAL units for NNPFC SEI messages or NNPFA SEI messages. These messages may provide description and data for a base neural network model or for an update of a neural network model. Each neural network model (base or update) may be described as a metadata item in the ‘meta’ box 504 in an item information box 540. For example, the metadata item 541 is the base model of a neural network post filter with filter identifier 0. As well, 542 is the base model of a neural network post filter with filter identifier 1. Following metadata items 541-1 or 541-2 correspond to updates of the neural network post filter with filter identifier 0. As well, metadata items 542-1 or 542-2 correspond to updates of the neural network post filter with filter identifier 1. These metadata items are indicated by encapsulation module and identified by parser module through a specific item_type. For example, ‘cnnr’ when they correspond to Compressed Neural Network Representation as specified in MPEG-7 part-17 or more generally as ‘pfii’ for Post-Filter Information Item when the actual representation format is specified elsewhere (for example using the item_uri_type of the ‘iinf’ box). The arrows between metadata items for post filtering information indicate decoding dependencies from a metadata item corresponding to an update to a metadata item corresponding to a base. They can be described using an item reference box with a specific item reference type, for example ‘nnrd’ for “Neural Network Representation Dependency” or ‘pfid’ for “post-filter information dependency” (4CC and names are just examples). Alternatively, the item reference may reuse an existing item reference type for decoding dependency between items. The ItemLocationBox (‘iloc’) 545 indicates the location of the data corresponding to a metadata item in the MediaDataBox 505. For example, when applied to MPEG video codecs like VVC and the neural network-based post filter SEI messages, 541 or 542 may contain a description of post-filter information with the actual payload from the VVC bitstream located in 551-1 data units (for example NNR units according to MPEG-7 Part-17) and 551-2 data units respectively (data units may be MPEG-7 NNR units or NAL units for NNPFC SEI messages or NNPFA SEI messages). A metadata item for post-filter information may be associated with an item property described in a ‘ipco’ box like 547 (within an ‘iprp’ box 546). The arrows between metadata items 541 or 542 to a property in the ‘ipco’ box may be described within an ‘ipma’ box. A specific item property ‘nnpf’ is defined to store a description of post-filter metadata items. One item property for post-filter information may be associated with several metadata items for post-filter information. The content of this item property may be the same set or a subset of the parameters described for generic post-filter information in previously described embodiments (for example parameters providing a filter identifier, the purpose of the filter, complexity, or the indication about internal or external payload, same origin bitstream or not . . . ). In the specific case of MPEG video codecs like VVC and related NNPFC and NNPFA SEI messages, the ‘nnpf’ property may contain generic description obtained from analysis of or a copy of a part of the syntax elements for these SEI messages. The payload of the SEI messages when present would remain in the data part of the media file, for example a MediaDataBox like 505.

Finally, the media samples described in the Sample Table Box 530 may be associated with metadata items 541, 542 . . . via the ‘stmi’ sample group allowing association between group of samples and one or more items. This association indicates which filter(s) apply to which sample or group of samples. This association is represented by ellipses 531 to 534 and dashed arrows from an ellipse to one or more metadata items.

An example of a generic item property for post-filtering information may be described as follows:

| aligned(8) class PostFilteringProperty | |
|---|---|
| extends ItemFullProperty(‘pfip’, version = 0, flags = 0) { | |
| unsigned int(1) post_filter_without_payload; | |
| unsigned int(1) | post_filter_same_bitstream; |
| unsigned int(1) | post_filter_update; |
| unsigned int(5) | post_filter_purpose; |
| utf8string | post_filter_identifier; |

}

With the same semantics as in the embodiment for generic post-filter information.

An example of a more specific item property for post filtering based on neural network could be described as follows:

```
aligned(8) class NNPostFilteringProperty
extends ItemFullProperty(‘nnpf’, version = 0, flags = 0) {
  unsigned int(1) nnpfc_external_payload;
  unsigned int(1) nnpfc_purpose;
  unsigned int(1) nnpfc_complexity_info_present_flag;
  if (nnpfc_complexity_info_present_flag) {
    unsigned int(32) nnpfc_num_kmac_operations_idc;
    unsigned int(32) nnpfc_total_kilobyte_size;
  }
}
```

or in a variant that is byte aligned and that supports the same range of filter purpose as in V-SEI:

```
aligned(8) class PostFilteringProperty
extends ItemFullProperty(‘pfip’, version = 0, flags = 0) {
  unsigned int(1) post_filter_{——}external_payload;
  unsigned int(10) post_filter_{——}purpose;
  unsigned int(1) post_filter_{——}complexity_info_present_flag;
  unsigned int(4) reserved;
  if (nnpfc_complexity_info_present_flag) {
    unsigned int(32) post_filter_{——}num_kmac_operations_idc;
    unsigned int(32) post_filter_{——}total_kilobyte_size;
  }
}
```

or in another variant providing a URI to access to external post-filter information and an identifier of the post filter:

```
aligned (8) class PostFilteringProperty
extends ItemFullProperty(‘pfip’, version = 0, flags = 0) {
  unsigned int(32) post_filter_id;
  unsigned int(1) post_filter_external_payload;
  unsigned int(10) post_filter_purpose;
  unsigned int(1) post_filter_complexity_info_present_flag;
  unsigned int(4) reserved;
  if (nnpfc_external_payload) {
    utf8string post_filter_uri;
    utf8string post_filter_tag_uri; // optional
  }
  if (nnpfc_complexity_info_present_flag) {
    unsigned int(32) post_filter_num_kmac_operations_idc;
    unsigned int(32) post_filter_total_kilobyte_size;
  }
}
```

It is to be noted that the same variants could apply to post-filter described by NNPFC SEI message or Neural network based post filters (e.g. the NNPostFilteringProperty) with the same semantics in described in the variants of the embodiment for mapping post-filter SEI message in metadata of a media track except that here the mapping is done in metadata items. The semantics for additional parameters in the variants is as follows:

where post_filter_id indicates the identifier for the post-processing filter. For example, it may correspond to the nnpfc_id specified in ISO/IEC 23002-7 when the post-filter is a Neural network based post-filter.
where post_filter_uri contains a URI with syntax and semantics as specified in IETF Internet Standard 66 identifying the neural network used as a base post-processing filter or an update relative to the base post-processing filter with the identifier as in the npfc_id field. For example, it may correspond to the nnpfc_uri as specified in ISO/IEC 23002-7 when the post-filter is a Neural network based post-filter.
Where post_filter_tag_uri provides a unique identifier of the format of the post-filter. For example, it may correspond to the nnpfc_tag_uri as specified in ISO/IEC 23002-7 when the post-filter is a Neural network based post-filter.

For the mapping of NNPFC or NNPFA SEI messages, the ‘stmi’ sample group associates the samples to the one or more metadata items for post-filter information that apply to the mapped samples. It is to be noted that the metadata items may be associated to image items, for example through a specific item reference type. Metadata items may also be associated with samples of an image sequence track, still using a ‘stmi’ sample group.

Back to the example on FIG. 5, the ‘stmi’ sample group would consist in a SampleToGroupBox (‘sbgp’) with grouping_type equal to ‘stmi’ and a SampleGroupDescriptionBox (‘sgpd’) with the same grouping_type value ‘stmi’. A first entry 531 in this ‘sbgp’ box would map samples S1 and S2 to a first group description entry indicating one item_ID for the metadata item represented on 542-1. This item depends on the metadata item 542. Item 542-1 is an update while item 542 is the base model for the post-filter. Another entry in the sbgp box 532 would map samples S4 and S5 to another sample group description entry indicating two item_IDs, one for metadata item 541-1 and one for metadata item 541-2, both depending on metadata item 541. When a sample is mapped to several metadata items for post-filtering as in the ‘sbgp’ entry 532, the item order in the ‘stmi’ sample group description entry should follow the order of post-filter operations. While the entry 532 links samples to items describing post-filter that correspond to updates of a same base model, 541, the same mechanism applies for updates from different base models. For example, the ‘stmi’ sample group may map one or more samples later on the sequence (not illustrated) to items 541-2 and 542-2 which are updates of base models 541 and 542 respectively. A third entry in the ‘sbgp’ (533) would map sample S6 and S7 to a sample group description entry containing one item_ID corresponding to the metadata item represented as 541-2. Each entry in the ‘sgpd’ box contains a parameter called meta box handler type that informs about the type of metadata scheme used by the MetaBox which is referenced by the items in this sample group. Its value may be set to the generic value ‘meta’ to indicate that the item provides metadata for the sample. This is suitable and safe as soon as there is no other MetaBox included in the track conveying the ‘stmi’ sample group or in the moov box with a handler type also set to ‘meta’. To avoid any ambiguity, a specific value (as a 4CC) may be used to indicate MPEG-7 compressed neural network representation (for example ‘cnnr’) like the item_type, or a HandlerProperty may be included in the ‘ipco’ box 547 associated to metadata items for post-filter information (541, 542, 541-1 . . . ). In this HandlerProperty, the handler type value may be set to ‘cnnr’ if post-filter(s) are compressed neural network representation or ‘pfif’ for generic post-filter information. This handler property may be shared for all metadata items describing post-filter information in the file, as soon as they have the same item_type. Concerning the item_IDs for the metadata items describing post-filter information, their value may differ from the nnpfc_id parameter conveyed in the NNPFC SEI message or from a post-filter identifier. In some very specific configurations (items in a media file only consisting in NN-based post-filter base models), then the item_ID could be the post-filter identifier. But in most cases, and for more flexibility, the post-filter identifier comes as a property of the metadata item describing the post-filter and can be part of a metadata structure providing post-filter information like for example an item property like ‘nnpf’ contained in box 547. In a variant for the usage of metadata items to describe post-filter information and ‘stmi’ sample group to link samples to post-filter information, the ‘stmi’ sample group may use the grouping_type_parameter (of the SampleToGroupBox with grouping_type=‘stmi’) to map samples either to a base filter or to an update filter, depending on the value of this grouping_type_parameter. This parameter could also be used to indicate a version of the post-filter, instead of base or update indication. For example, still based on FIG. 5, the entries 531, 532, 533 and 534 in a sbgp box with grouping_type=‘stmi’ may have a value of grouping_type_parameter indicating an update or a version for the metadata item 542-1. A sample using a base model like item 541 or 542 would be mapped in a sbgp box with grouping_type=‘stmi’ and a grouping_type_parameter indicating a base post-filter. With this variant, the indication of base or update filter in the metadata structure providing post-filter information (e.g. an item property like ‘nnpf’ contained in box 547) may become optional. It is to be noted that the indication of a version, possibly as a version number or version identifier, may rely on information from a bitstream representing the Neural Network model used for the post filtering. For example, in MPEG NNR representation, the bitstream may provide an explicit list of the version of the Neural Network model that are contained in the bitstream. It may be a single list at the beginning of the stream or an initial list that may be complemented throughout the stream. The versions may have an explicit identifier (recommended for such a use case), or implicit identifiers (i.e. identifier is “just” the index of the version in the list of versions). The list may be available in the base model (so in one item) or in an initial list in the base model (one item) followed by complements in updated model (one or more other items). Encapsulation module may decide to embed several versions of a same model in a single item or multiple items describing the post-filter. In the case of NNPFC and NNPFA SEI messages, using one item per version of the model is convenient: one item payload will correspond to one NAL unit for a NNPFC SEI message. When one or more versions or base plus update are stored in one item, the indication of dependencies may not be necessary if each item is self-contained (i.e. contains all the data for a complete version of the Neural Network model) Then, the list of versions embedded in this item may be indicated as a property of this item (for example in ‘nnpf’ properties in the ‘ipco’ box 547, rather than in the grouping_type_parameter of the ‘stmi’ sample to group box.

FIG. 5 explains the use of metadata items to describe post-filter information, like NNPFC SEI messages and the use of ‘stmi’ sample group to associate samples to the metadata items describing post-filter(s) to apply onto these samples. This activation of filters onto specific video frames is the object of the NNPFA SEI message. This translation of NNPFA SEI message to the ‘stmi’ sample group requires the encapsulation module to interpret the NNPFA SEI message to detect when a given post-filter is active and when it is not. This can be done by parsing the body (e.g. the values for target_id, for the cancel_flag and for the persistence flag when present) of the NNPFA SEI message(s) which is quite simple. This is done for example during step 204. When the cancel_flag is equal to 0, the sample (containing the NNPFA SEI message(s)) has to be mapped to an entry in the stmi SampleGroupDescriptionBox. The encapsulation module has to determine if an existing entry can be reused or a new entry should be created. To do so, the encapsulation module lists the nnpfa_target_id(s) for the current sample, looks for metadata items associated to these filter identifiers and creates a new entry in the stmi SampleGroupDescriptionBox if the determined list of metadata items is a new one. If the stmi SampleGroupDescriptionBox already contains an entry with the determined list of metadata items, the sample is then mapped to this sample group description index in the stmi SampleToGroupBox. Then, if the persistence_flag is set for the one or more NNPFA SEI messages, the following samples are mapped to the same sample group description entry until a NNPFA SEI message with a cancel_flag=1 is encountered by the encapsulation module in step 204. As soon as the number of NNPFA changes or at least one filter is cancelled, the encapsulation module reconsiders the mapping of the current sample. From parser side, there is an equivalent processing to operate when a NNPFA SEI message has been translated into a stmi sample group at encapsulation time. This can be done at steps 303 and 304. Step 303 determines that a sample is actually associated with post-filter information if it is mapped to a sample group description entry of type stmi. If it is the first sample mapped to a given ‘stmi’ entry, the parser prepares a number of NAL units of type NNPFA SEI message equal to the number of times indicated in the stmi sample group description entry with a nnpfa_target_id equal to the post-filter identifier associated with the associated metadata items (indicated by the item_ID), cancel_flag set to 0 and persistence value to 1 if following samples are mapped to the same sample group description entry. If only one sample is mapped, persistence-flag is set to 0. The same operation occurs on the last sample that is mapped to a stmi sample group description entry: the parser creates a number of NAL units of type NNPFA SEI message equal to the number of items indicated in the stmi sample group description entry with a nnpfa_target_id equal to the post-filter identifier associated to the metadata items (indicated by the item_ID) and cancel_flag set to 1. The so constructed NAL units are then appended in the reconstructed bitstream for the post-filtered video. As well, to reconstruct the NNPFC SEI messages, storing them as items offers some flexibility. Indeed, they can be accessed in the media file when needed or on-demand. For example, they can be obtained from the ItemLocationBox 545 providing byte offsets in the media data box. When there is no constraint on startup delay, they may be inserted at the beginning of the reconstructed bitstream just by copying the byte range for a post-filter metadata item since the byte range corresponds to a NNPFC SEI NAL unit. When there are constraints on startup delay from application point of view, the NAL units corresponding to post-filter metadata items may be inserted in the reconstructed bitstream after some samples. The NAL units corresponding to NNPFA SEI messages should be delayed in the bitstream accordingly (i.e. should not be present before the target NNPFC SEI message). As well, NAL units corresponding to base models should be inserted before NAL units for update models. In the general case, the data corresponding to a metadata item describing post-filter operation or information can be inserted in the bitstream at the beginning of the data corresponding to a sample using this post-filter. In case of random access, the item information (541, 542 . . . ) and the item location box 545 provide byte range to request or to read post-filter information on demand. Thus, there is no need to duplicate the data for post-filter in synchronization samples. When encapsulating a media sample as a synchronization or as a random access sample, possibly using a post-filter (as indicated in the NNPFA SEI message for example), this sample should be mapped in ‘stmi’ to appropriate metadata items, so that the activation of the post-filters is properly indicated (i.e. consistent with the content of the NNPFA SEI messages) and so that media players can extract or reconstruct a NNPFA SEI NAL unit(s) for this sync or rando access sample. The encapsulation of NNPFC SEI messages in steps 207 and 208 consists in getting the NAL units for NNPFC message, inserting them in the media data, describing the byte offset in the media data in the ItemLocationBox 545 and associating with a metadata item created as an item information entry. The encapsulation module may extract some parameters from the NNPFC SEI message (or obtain it from application settings or by user interface) and stores it as an item property in the ipco box 547 or dedicated structure to store generic post-filter information.

In case several stmi sample groups are used to link samples to metadata items, for different purposes, the specific link for post-filter can be indicated by using the grouping_type_parameter (for example set to ‘cnnr’ or ‘pfif’). However, when used for this purpose, it cannot be used to indicate base or update or version of a post-filter (these indications may then be described in item properties or other means described above like for example a dedicated box or a sample group description).

### Indication of Post-Filter Information as a Combination of Sample Group and Information Item

Having the NNPFC payload inside the samples of the video track will unavoidably lead to the duplication of this data when the media file is provided with random access (e.g. with synchronization samples). Indeed, it will be necessary to repeat this payload in each synchronisation or random-access sample. On the other hand, having NNPFC payload in the metadata of the media file may induce delay at startup when the size of the model reaches megabytes and does not help players in determining that post-filter is available and for which purpose.

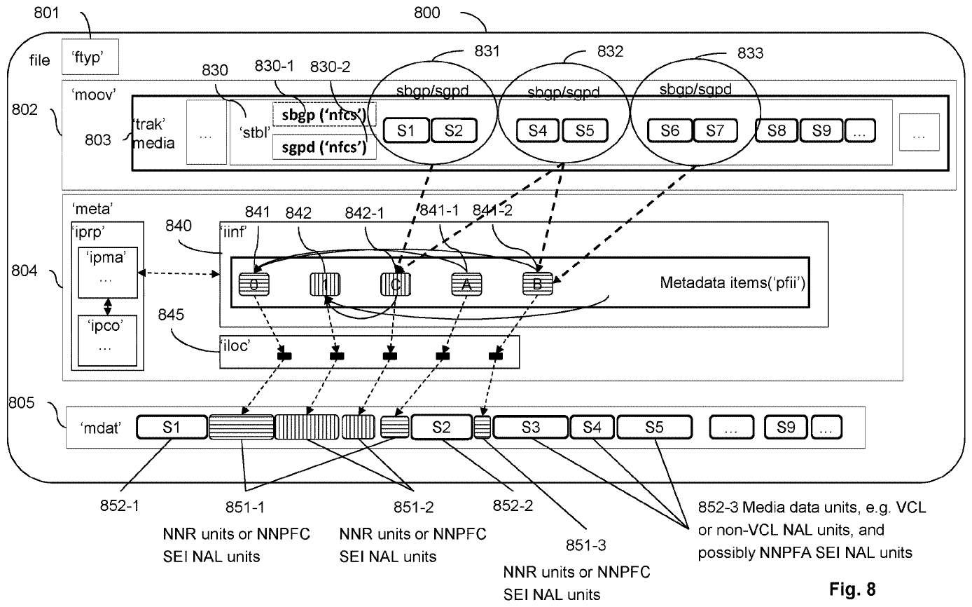

FIG. 8 illustrates this embodiment, in which it is proposed:
to expose parameters describing the NNPFC as a sample group of the media (e.g. video, audio, volumetric . . . ) track 803, but
to store NAL units corresponding to NPFC SEI messages as metadata items in a the data part 805 of the media file 800,
To map media samples to their active NNPFC(s), using ISOBMFF's Sample-to-item sample group (‘stmi’) (831, 832, 833),
to keep NAL units corresponding to NNPFA SEI messages in the sample data 805.

This embodiment provides some advantages:
No need to duplicate NNPFC's payload (when present) for each synchronization sample,
No need for specific signaling of the NNPFA SEI message, handled by a ‘stmi’ sample group,
Ability for application to skip or not the post-filtering, based on the NNPFC description in the media track,
Preserve the fast start, fast seek for the media, the metadata item not necessarily being downloaded at startup but when the filter is activated
Access to payload for the post-processing filter, when present, through a metadata item.

According to this embodiment, it is proposed to describe NNPFC as a sample group and metadata item and to describe NNPFA as link(s) between media samples and metadata item(s), using the ‘stmi’ sample group.

Each neural network model (base or update) is described as a metadata item (841, 842, 842-1 . . . ) for post-filter information identified by the item_type value ‘pfii’ (for post-filter information item, any dedicated 4CC could be used provided that it does not conflict with existing and registered ones). The actual format and the description for the post-processing filter are specified in the ‘nfcs’ sample group (830-2 and possibly 830-1) describing post-processing filter as defined hereafter. The NAL units corresponding to a NNPFC SEI message shall be stored in the data for a metadata item (851-1, 851-2, 851-3).

A sample mapped to NnpfcSeiSampleGroupEntry contains a description of one or more NNPFC SEI messages (within 830-1). For each contained NNPFC SEI message, the sample group description (830-1) indicates whether the sample contains the base post-processing filter (841 or 842) or an update (841-1, 841-2 or 842, 1) of the post-processing filter. When a sample is not mapped to NnpfcSeiSampleGroupEntry the sample does not contain any description for NNPFC SEI messages.

In this embodiment, instances of the SampleToGroupBox for the NNPFC sample group may include grouping_type_parameter. The grouping_type_parameter field is specified for the NNPFC sample group. as follows:

```
{
  unsigned int(1) filter_update_flag;
  unsigned int(31) filter_id;
}
```

filter_update_flag equal to 1 indicates that all the sample group description entries referenced by this SampleToGroupBox contain an NNPFC SEI message that provides an update on top of a base post-processing filter. filter_update_flag equal to 0 indicates that all the sample group description entries referenced by this SampleToGroupBox contain an NNPFC SEI message that specifies a base post-processing filter. This is particularly useful when one metadata item does not mix update and base versions of a post-filter. Otherwise, a list of filter_id may be provided in a loop within the sample group description entry and the grouping_type_parameter should not be used.

filter_id indicates that all the sample group description entries referenced by this SampleToGroupBox contain an NNPFC SEI message that has nnpfc_id equal to filter_id.

When a track (803) contains an NNPFC sample group (830-2 and possibly 830-1), no NAL units for the NNPFC SEI messages should be present within the sample entries or samples of the track.

Preferably, a sync sample is mapped to a NnpfcSeiSampleGroupEntry.

When a reader supports the NNPFC sample group, it should also support the metadata item for post-filter information and it performs for the mapped samples the insertion of prefix SEI NAL units corresponding to NNPFC SEI messages as a part of the bitstream reconstruction. The ItemLocationBox (‘iloc’) 845 associated to the metadata item for post-filter information indicates the location of the NAL units corresponding to the NNPFC SEI message (851-1, 851-2 and 851-3) in the media data box 805 (or item data box, or identified media data box).

According to this embodiment, the sample group description entry (within 830-2) describing post-processing filter can be expressed as follow:

```
aligned(8) class NnpfcSeiSampleGroupEntry( ) extends
VisualSampleGroupEntry(‘nfcs’)
{
  unsigned int(32) nnpfc_item_ID;
  unsigned int(1) nnpfc_external_payload;
  unsigned int(5) nnpfc_purpose;
  unsigned int(1) nnpfc_complexity_info_present_flag;
  unsigned int(1) reserved;
  if (nnpfc_complexity_info_present_flag) {
    unsigned int(32) nnpfc_num_kmac_operations_idc;
    unsigned int(32) nnpfc_total_kilobyte_size;
  }
}
```

With the following semantics

nnpfc_external_payload indicates, when set to 1, that the payload for the post-processing filter is external to the file. When set to 0, the payload is present in the data part of the file, in a metadata item for post-filter information.

nnpfc_item_ID indicates the item identifier for the metadata item storing the SEI NAL units for post-processing filter described in this sample group description entry

nnpfc_purpose indicates the purpose of the post-processing filter as specified in Table 20 of ISO/IEC 23002-7.

nnpfc_complexity_info_present_flag specifies whether one or more syntax elements that indicate the complexity of the post-processing filter associated with the filter_id are present (when set to 1) or not (when set to 0).

nnpfc_num_kmac_operations_idc indicates the maximum number of multiply-accumulate operations per sample as specified in ISO/IEC 23002-7.

nnpfc_total_kilobyte_size indicates a total size in kilobytes required to store the uncompressed parameters for the neural network as specified in ISO/IEC 23002-7.

It is to be noted that the above sample group description entry may contain other parameters from the generic description of post-filter information or from the syntax of a NNPFC SEI message when useful for the application.

A sample onto which post-processing filters are activated shall be mapped to a sample-to-item (‘stmi’) sample group. The ‘stmi’ sample group associates the samples to the one or more metadata items for post-filter information that are activated for the mapped samples (as illustrated with 831, 832 and 833). The order of application of the post-filters onto a sample is their ordering inside the ‘stmi’ sample group, unless the description of the post-filter contains parameters for different orders or relations than sequential, e.g. parallel or alternatives). The scheme_type within the ‘stmi’ sample group shall be set to ‘meta’. The NAL units corresponding to NNPFA SEI messages are stored in the samples 805 of the video track. Optionally, metadata items (841, 842, 842-1, 841-1 and 841-2) may be associated to item properties via the ‘ipma’ box 844, for example property further describing the post-filter.

In another embodiment combining sample group and metadata items, metadata items as on FIG. 5 are used to describe post-filter information and the location of their payload. However, the properties that expose a subset of the parameters of the NNPFC SEI message (as the possible list of parameters in the generic post-filter information) are still described in the media track using these post-filters like depicted on FIG. 4a (as any variants of box 414 or of sample group 415 and 416). It is to be noted that box 416 may not be present when all samples map to the same post-filter information, i.e. when using default sample grouping or sample group with static mapping for the description of the post-filter information. Then, from this sample group (415 and 416 or 415 only, or from box 414) for post-filter information, parser can deduce which sample may be related to one or more post-filters. If the parser or application decides to use and apply the post-filter, it can get access to the payload through the metadata items for post-filter information (e.g. 541, 542, 541-1 . . . ), when present in the file (as indicated in one parameter of post-filter description). To identify the relevant metadata items (i.e. which post-filter(s) apply to which samples), a parser can use the ‘stmi’ sample group in the media track, as explained in previous embodiment. Once identified, the item location box provides the byte range to the payload for the used post-filter(s) that can be copied to the reconstructed bitstream. In the case of NNPFC and NNPFA SEI messages indicating post-filter information, this payload may consist in NAL units for NNPFC SEI messages or/and NAL units for NNPFA SEI messages. Alternatively, the units for NNPFA SEI messages.may not be described as data for the metadata items but deduced from the ‘stmi’ sample group description entry, as explained in embodiment “Indication of post-filter information as information item”

In an alternative to the use of a first sample group for filter description and a second sample group to link media samples to metadata items, a new sample group may be used with sample group description entries that, in addition to a post-filter description, contains the indication of an item identifier describing the post-filter payload. Then, for cases where the bitstream does not contain any payload for the post filter (e.g. nnpfc_mode_idc different than 0), the item identifier (e.g. nnpfc_item_ID) is optional. The presence or absence of this item identifier may be indicated by the post_filter_without_payload or post_filter_external_payload in the generic description of the post-filter. For cases where the bitstream does contain a payload for the post filter, the post_filter_without_payload or post_filter_external_payload can be set to false and an item identifier is provided to locate this payload in the data. With this alternative, the item may not have any associated item property exposing post-filter information since these properties are described in the new sample group description entry (e.g. ‘nfcs’ sample group in the media track). However, the dependencies (e.g. as the item reference of type ‘nnrd’ or ‘pfid’) between the metadata item describing post-filter information may be useful to locate an update and its base model in the data (e.g. in a MediaDataBox), when base and update models are stored in different items.

### Indication of Post-Filter Information as Deductive Information

A possible representation of post-filter information as metadata items can rely on HEIF's deductive items (instead of specific metadata items like ‘cnnr’ described according to FIG. 5). Deductive information is a type of metadata that is related to an image and generated by an image analysis process or manually. Image context analysis, object detection or face detection are examples of such algorithms that generate deductive information. Deductive information can be stored as an opaque data block in an item with an item type equal to ‘uri’. Opaque here means a specific format that may not be handled by generic ISOBMFF or HEIF reader. An item_uri_type of ItemInfoEntry box shall contain the absolute URI which uniquely identifies the specification of deductive information (the format of the opaque data block). To use deductive items to describe post-filter information, this URI could be set to the nnpfc_uri indicated in the NNPFC SEI message when post filter comes as defined in V-SEI specification. The deductive item could also be extended with a tag_uri to support the nnpfc_tag_uri or associated to an item property providing more parameters describing the post-filter (the parameters or a subset of the parameters listed in the generic post-filter information), for example a ‘nnpf’ item property as on 547 (or a more generic ‘pfif’ item property). Having deductive item associated to a post-filter property improves the interoperability compared to the existing design that only allows associate to ‘uuid’ properties. These are user-defined and thus non interoperable in open systems (where writer and parser are not controlled by the same application provider or developer). The deductive item for post-filter could be linked to samples it applies reusing the ‘stmi’ sample group as described in previous embodiments to also handle the activation and cancellation of post-filters. The SEI NAL units corresponding to the NNPFA SEI message may be stored as item data as in embodiment “Indication of post-filter information as a combination of sample group and information item” or may not be stored and rather reconstructed on-demand when reaching a sample mapped to a metadata item describing post-filter information (as in embodiment “Indication of post-filter information as information item”) A deductive item for an update of a post filter could reference the deductive item describing its base post-filter using the generic item reference with type ‘dpnd’ or a specific reference type for post-filter dependencies like ‘nnrd’ for “Neural Network Representation Dependency” or ‘pfid’ for “post-filter information dependency” (4CC and names are just examples). The data for a deductive item may correspond to the NAL units of the NNPFC SEI message when the post-filter information comes as an SEI as specified in V-SEI specification. The processing would differ compared to current cascaded deductive items as defined in HEIF, in the sense that the cascade here, or the dependency would consist in applying the update onto the base and then applying the result onto the associated samples. This would not be a cascade of operations as currently specified in HEIF. To avoid the confusion, another item reference type may then be used to indicate a combination of deductive items before their application to associated items or samples.
One advantage of having post-filter described as a metadata item is that when a media track has one or more associated items (for example cover image or thumbnail or preview for a video track) the post-filter information may also be applied to these one or more associated items in order to render improved versions of these items (for example, enhanced thumbnail or preview). It is to be noted that different item_types, more or less generic, may be used to describe metadata items describing post-filter information. The more generic is the item_type, the more additional parameters (within the item description, e.g. in ‘infe’) or additional properties are required to describe the exact format, purpose of the post-filter information. Possible item_types from less generic to more generic can be for example: ‘cnnr’ for explicit indication of a MPEG-7 NNR based post-filter, ‘pfii’ or ‘pfif’ for generic post-filter, with an associated property providing purpose, format . . . , ‘uri’ possibly with a parameter indicating the format of the post-filter and possibly an associated item property, ‘mime’ that requires to set proper value in the content encoding parameter (e.g. or in associated item property.
Another advantage to have data for post-filter to be stored in an item is that the data for post-filter may be requested, loaded, read or processed “on-demand” by readers or media players. This means that reader has knowledge from the top-level metadata of the file of the position of the different post-filter data. Then, when it decides to apply the post-filtering, it can request (if file is exchanged or streamed over a communication network) or process (if local) these data only when needed. For example, it can append NAL units representing the post-filter just before a sample onto which it decides to start applying post-filtering. There is no need to append these data from the beginning of the reconstructed bitstream, as soon as the order between base and update filters guarantees that an update always comes after its base.

### Indication of Post-Filter Information as Specific Track

FIG. 6 illustrates an embodiment where the post-filter information is encapsulated in a dedicated track 630. The track defines a specific sample entry type, for example ‘cnnr’ for Compressed Neural Network Representation when the samples correspond to one or more NNR units as specified by MPEG-7 Part-17. The sample entry may have another type if the data correspond to other data unit types, for example SEI NAL units from V-SEI specification. The sample entry may then be ‘nnpf’ for Neural Network-based Post Filter samples. The MediaData Box 630 contains samples for media track 610 and for post-filter track 630. The track 610 may be a classical video track (for example a ‘vvc1’ track) plus a specific track reference indicating that this track is associated with a post-filter track. This may be indicated by a new track reference type like ‘pfdc’ for Post-Filter Description. In a variant, the track association may go from post-filter track to the media track, using the same track reference type or a specific one that does not conflict with other registered ones. The post-filter track has a specific sample group to describe post-filter information, for example using a sample group mechanism as illustrated in 635 and 636. This sample group has a specific grouping_type (for example ‘pfif’, providing a description of the post-filter information (similarly to the ‘nnpf’ item property) or ‘nfas’ and ‘nfcs’ grouping_types when the track carries SEI NAL units for Neural network based post-filter with the same parameters as in nfcs and nfas sample group description entries. To associate media samples from track 610 to samples in the post-filter track 630, the samples in the track 630 may be time aligned with the media samples, so that a sample in the media track applies to the time aligned sample in the media track. There may be several post-filter tracks, several time aligned samples with a media sample, that can be interpreted as multiple post-filter operation onto a given media sample. The order of filter operations may follow the order of track references from post-filter tracks 630 to the media track 610.

It is to be noted that depending on how and what kind of information is available to the encapsulation module at step 204, the encapsulation module may select one of the above embodiments, considering for example what information is provided in the media bitstream:
1. If no post filter description (test 202 false) is provided in the bitstream but may be provided out of band (step 203), the encapsulation module may prefer the approach of the second or third embodiment where post-filter information is described outside the media track.
2. If post-filter description is provided in the bitstream (test 202 true), the encapsulation module may prefer the approach of the first or second embodiment and when bitstream is VVC bitstream with NNPFC and NNPFA SEI messages it may prefer the variants with nfcs and nfas sample grouping or the item-based approach.

In the above embodiments, it is to be noted that the media track 410 or 503 or 610 may be a video track, an audio track, a volumetric track possibly video-based track like a geometry or attribute track, any media track that can be improved by a post-filtering operation. For example, a media track encapsulating volumetric media like one or more video tracks (e.g. MPEG V-PCC or V-DMC) may benefit from post-filtering operation like conversion of the decoded video frames to a nominal format (e.g. a nominal resolution, bit depth, chroma format, etc.). This may be done before providing decoded frames to a reconstruction process of the volumetric media, Each, or a subset of the one or more video tracks encapsulating volumetric media may be associated to post-filter information according to one of the embodiments described in reference to FIG. 4, 5 or 6. As well, post-filter identifier was explained as an identifier for one post-filter. However, if the bitstream provides identifier for a group of filters to be applied to a same set of samples, the above descriptions would apply as well, the post-filter identifier being the identifier of the group of filters. For example, when used with the NNPFC and NNPFA SEI messages, an identifier for a group of post-filters may be declared in a NNPFC SEI message and used in some NNPFA SEI messages to activate or cancel this set of post-filters. When post-filters are grouped, there may additional parameters like complexity or processing requirements that describe the characteristics for the set of filters. This may be taken into account in generic description of post-filter information as either a parameter for complexity that would then describe the group or as a loop on each post-filter of the group to provide the complexity for each post-filter of the group. Some processing rules may be described in a NNPFC SEI message like whether the filters are applied in sequential, in parallel or should be considered as alternatives. These are parameters, for example in NNPFC SEI messages, that could also be provided in generic description of post-filter information.

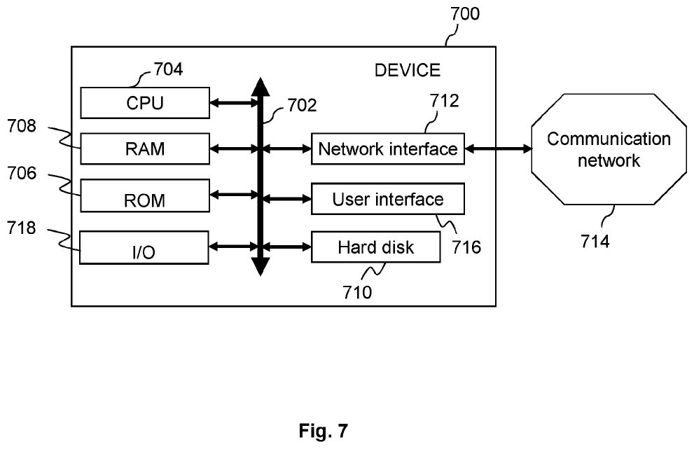

FIG. 7 is a schematic block diagram of a computing device 700 for implementation of one or more embodiments of the invention. The computing device 700 may be a device such as a micro-computer, a workstation, or a light portable device. The computing device 700 comprises a communication bus 702 connected to:
a central processing unit (CPU) 704, such as a microprocessor;
a random access memory (RAM) 708 for storing the executable code of the method of embodiments of the invention as well as the registers adapted to record variables and parameters necessary for implementing the method for encapsulating, indexing, de-encapsulating, and/or accessing data, the memory capacity thereof can be expanded by an optional RAM connected to an expansion port for example;
a read only memory (ROM) 706 for storing computer programs for implementing embodiments of the invention;
a network interface 712 that is, in turn, typically connected to a communication network 714 over which digital data to be processed are transmitted or received. The network interface 712 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 704;
a user interface (UI) 716 for receiving inputs from a user or to display information to a user;
a hard disk (HD) 710; and/or
an I/O module 718 for receiving/sending data from/to external devices such as a video source or display.

The executable code may be stored either in read only memory 706, on the hard disk 710 or on a removable digital medium for example such as a disk. According to a variant, the executable code of the programs can be received by means of a communication network, via the network interface 712, in order to be stored in one of the storage means of the communication device 700, such as the hard disk 710, before being executed.

The central processing unit 704 is adapted to control and direct the execution of the instructions or portions of software code of the program or programs according to embodiments of the invention, which instructions are stored in one of the aforementioned storage means. After powering on, the CPU 704 is capable of executing instructions from main RAM memory 708 relating to a software application after those instructions have been loaded from the program ROM 706 or the hard-disc (HD) 710 for example. Such a software application, when executed by the CPU 704, causes the steps of the flowcharts shown in the previous figures to be performed.

In this embodiment, the apparatus is a programmable apparatus which uses software to implement the invention. However, alternatively, the present invention may be implemented in hardware (for example, in the form of an Application Specific Integrated Circuit or ASIC).

Although the present invention has been described hereinabove with reference to specific embodiments, the present invention is not limited to the specific embodiments, and modifications will be apparent to a person skilled in the art which lie within the scope of the appended claims.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating media data into an ISOBMFF based media file, the media data comprising media data units, and a post-filter data unit, the post-filter data unit comprising parameters describing post-filter characteristics, the method comprising:
generating a first track representing a sequence of samples, each sample comprising at least one of the media data units, the post-filter data unit describing a post-processing filter applying to at least one of the samples of the first track, a metadata part of the first track comprising at least one parameter from the parameters of the post-filter data unit; and
generating a media file including the first track and comprising, in a data part of the media file.

2. The method of claim 1, wherein the data part of the media file comprising the part of the post-filter data unit is a data part of the first track.

3. The method of claim 1, wherein the post-filter data unit further comprises a post-filter payload bitstream and the method further comprises:
generating, in the media file, an entity associated with the first track and describing the data part of the media file comprising the part of the post-filter data unit,
wherein the metadata part of the first track comprises the parameters of the post-filter data unit and the part of the post-filter data unit comprised in the data part of the media file is the post-filter payload bitstream.

4. The method of claim 3, wherein the entity is an ISOBMFF based item.

5. The method of claim 3, wherein the post-filter payload bitstream is a neural network representation, NNR, bitstream.

6. (canceled)

7. The method of claim 53, wherein the parameters describing the post-filter characteristics comprises information indicating the purpose of the post-processing filter.

8. The method of claim 53, wherein the parameters describing the post-filter characteristics comprise information indicating the complexity of the post-processing filter.

9. (canceled)

10. The method of claim 1, wherein the parameters describing the post-filter characteristics comprise information indicating a base or an update.

11. (canceled)

12. The method of claim 31, wherein the metadata part of the first track comprising at least one parameter is a sample group description.

13. The method of claim 1, wherein the post-filter data unit is a neural-network post-filter activation, NNPFA, SEI message.

14. A method of generating media data from an ISOBMFF based media file, the method comprising:
obtaining, from the media file, a first track representing a sequence of samples, each samples comprising at least one media data unit;
obtaining, from a metadata part of the first track, at least one parameter describing post-filter characteristics;
obtaining, from a data part of the media file, a part of a post-filter data unit, the post-filter data unit describing a post-processing filter applying to at least one of the samples of the first track; and
generating the media data based on the at least one media data unit from the obtained first track, the at least one parameter and the obtained part of post-filter data unit.

15. (canceled)

16. A non-transitory computer-readable storage medium storing instructions of a computer program for implementing a method according to claim 1.

17. (canceled)

18. A device for encapsulating media data into an ISOBMFF based media file, the media data comprising media data units, and a post-filter data unit, the post-filter data unit comprising parameters describing post-filter characteristics, the device comprising a processor configured for:
generating a first track representing a sequence of samples, each sample comprising at least one of the media data units, the post-filter data unit describing a post-processing filter applying to at least one of the samples of the first track, a metadata part of the first track comprising at least one parameter from the parameters of the post-filter data unit; and
generating a media file including the first track and comprising, in a data part of the media file, a part of the post-filter data unit.

19. A device for generating media data from an ISOBMFF based media file, the device comprising a processor configured for:
obtaining, from the media file, a first track representing a sequence of samples, each sample comprising at least one media data unit;
obtaining, from a metadata part of the first track, at least one parameter describing post-filter characteristics;
obtaining, from a data part of the media file, a part of a post-filter data unit, the post-filter data unit describing a post-processing filter applying to at least one of the samples of the first track; and
generating the media data based on the at least one media data unit from the obtained first track, the at least one parameter and the obtained part of the post-filter data unit.

20. The method of claim 3, wherein the post-filter data unit is a neural-network post-filter characteristics, NNPFC, SEI message.

21. The method of claim 14, wherein the data part of the media file comprising the part of the post-filter data unit is a data part of the first track.

22. The method of claim 14, wherein the method further comprises:
generating a post-filter data unit comprising the obtained at least one parameter and the obtained part of a post-filter data unit; and
wherein obtaining the part of a post-filter data unit comprises obtaining, in the media file, an entity associated with the first track and describing the data part of the media file comprising the part of a post-filter data unit, the part of a post-filter data unit being obtained via the entity; and
generating the media data is based on the at least one media data unit from the obtained first track and the generated post-filter data unit.

23. The method of claim 22, wherein the entity is an ISOBMFF based item.

24. The method of claim 23, wherein the part of post-filter data unit comprises a post-filter payload bitstream, the post-filter payload bitstream being a neural network representation, NNR, bitstream.

25. The method of claim 23, wherein the generated post-filter data unit is a neural-network post-filter characteristics, NNPFC, SEI message.
